(19) United States
(12) Patent Application Publication
(10) Pub. No.: US 2025/0131521 A1
(43) Pub. Date: Apr. 24, 2025

(54) SYSTEMS AND METHODS FOR AUTOMATICALLY DETECTING A DEPLOYMENT EVENT

(71) Applicant: Wells Fargo Bank, N.A., San Francisco, CA (US)

(72) Inventors: David D. Perez, Huntersville, NC (US); Danny Mathon, Charlotte, NC (US); Brent Finnell, Charlotte, NC (US); Justin Blackburn, Litchfield Park, AZ (US); Walter Nelson Broadhurst, IV, Charlotte, NC (US)

(21) Appl. No.: 18/490,402

(22) Filed: Oct. 19, 2023

(51) Int. Cl. G06Q 50/26; G06Q 10/0631

(52) U.S. Cl. CPC G06Q 50/26; G06Q 10/06311

(57) ABSTRACT

Systems, apparatuses, methods, and computer program products are disclosed for automatically detecting a deployment event for a user. An example method includes identifying a user behavior data set associated with a user and determining a predicted deployment event for the user based on the user behavior data set. The example method further includes providing a deployment confirmation prompt to the user in an instance in which a deployment likelihood score is determined to satisfy a deployment likelihood score threshold. The example method further includes receiving a deployment confirmation response indicative of user confirmation or denial of the predicted deployment event, and, in an instance in which the user confirms the predicted deployment event, performing one or more proactive operations for the user.

### BACKGROUND

Active-duty service members are eligible for certain benefits and protections during their deployment. In particular, the Servicemembers Civil Relief Act (SCRA) is a federal statute that provides legal protections and benefits to active-duty service members, including capped interest rates, the right to terminate residential leases, eviction prevention, etc. These relief efforts help alleviate some of the financial and legal burdens service members face during their deployment.

### BRIEF SUMMARY

As described above, SCRA provides some legal protections and benefits to active-duty service members to ensure these individuals can focus on their deployment without undue financial and/or legal complications. However, while the SCRA statute provides these benefits to service members, the burden of realizing these benefits lies with the individual service member. In particular, service members are required to submit a request for protection under SCRA for individual, eligible user accounts. For example, a service member is required to submit separate, individual requests to cap interest rates on a mortgage, car loan, credit cards, etc. Additionally, the service member may need to separately request termination of a residential lease, stay of court proceedings, etc. This time-consuming and manual process places an additional burden on service members during an already difficult period when they are preparing to deploy. Furthermore, short-notice deployment orders may shorten the time window before deployment such that it is not feasible for service members to request relief pre-deployment. Thus, service members may be forced to seek relief during deployment, where communication means are limited, and thus, applying for deployment relief measures is even more burdensome for the service member.

Additionally, SCRA only provides protections for certain user accounts types. Other user accounts types, such as subscription-based accounts, membership accounts, etc., may not be recognized under SCRA and, thus, may easily be overlooked by service members. However, service members may be unable to utilize the services or products associated with these user accounts during their deployment and, thus, may wish to stop incurring charges for these services for at least the duration of their employment. Because these user account types are not eligible under SCRA, they may have variable offerings for active-duty service members, such as options to suspend or pause a user account until the end of a deployment and/or cancel a user account with or without a cancellation fee. However, these options may not be well-advertised to users and/or may require a third-party entity to evaluate such a request on a case-by-case basis. In either case, both options still require the user to manually submit a request to realize any potential protections and/or benefits.

To alleviate this manual burden from users, example embodiments described herein automatically detect when a user is deployed or is scheduled to deploy and may proactively perform operations that provide the user with protections and/or benefits offered by his/her associated user account during the deployment period. In particular, embodiments described herein may use a trained deployment identification machine-learning model to process a user behavior data set for the user and determine a predicted deployment event. The predicted deployment event may be associated with a deployment likelihood score that is indicative of the likelihood that the user is deployed during a time period of interest. Advantageously, embodiments described herein may infer an upcoming deployment for the user or may infer the user is currently deployed without requiring the user to explicitly notify the system. Rather, embodiments described herein may leverage user behavior data points and use a deployment identification machine-learning model to detect patterns that are indicative that a user is deployed. The deployment identification machine-learning model may be trained to identify specific user behavior data points, combinations of user behavior data points, changes in user behavior described by like user behavior data points, and/or the like, which are indicative of deployment and, further, may determine deployment indication scores indicative of the magnitude of a correlation between said user behavior data points, user behavior data point combinations, and/or changes in user behavior and a likelihood of deployment. The deployment identification machine-learning model may then determine a deployment likelihood score based on the one or more deployment indication scores.

Additionally, in some embodiments, the deployment identification machine-learning model may identify inferred associated users who are determined to be associated with an inferred user location corresponding to the user. That is, the deployment identification machine-learning model may identify other users who are determined to be within the same geographic location, region, or area and use this information to help determine the deployment likelihood score. These other users may correspond to service members who are within the same group, unit, squad, platoon, etc., such that they are deployed with the user. Thus, the deployment identification machine-learning model may improve the accuracy of the deployment likelihood score by leveraging user behavior data sets of other users.

In an instance in which the deployment likelihood score satisfies a deployment likelihood score threshold, the user may be presented with a deployment confirmation prompt, requesting the user to confirm or deny the predicted deployment event. If the user confirms the predicted deployment event, proactive operations may then be performed for the user. The particular operations performed may be based on the preferences of the user and based on the user accounts associated with the user. In some embodiments, an eligibility category may be determined for each identified user account, which may indicate whether the user account is eligible for federally provided relief (e.g., SCRA eligible), non-federally provided relief, or non-eligible for relief. One or more eligible user accounts may then be selected for the user. The system may perform various operations for these selected eligible user accounts based on the user account type the user account corresponds to and user preferences described by a user profile of the user. User preferences may be indicative of user preferences for particular user accounts or user account types with respect to how a third-party entity associated with the particular user account should be informed of the deployment event. Thus, the user preferences allow the user to control what proactive operations are performed for individual user accounts.

Based on the user account types of the selected eligible user accounts and user preferences, embodiments described herein may perform proactive operations to (a) automatically generate and provide deployment notifications to third-party devices of third-party entities that are associated with a selected eligible user account, and/or (b) may automatically generate relief documentation for a selected eligible user account and provide the relief documentation to the user. In both instances, the described system may automatically generate documentation that may allow the user to gain the benefits and/or protections of certain user accounts during his/her deployment. However, the provider of respective documentation may be the described system such that the user does not have to intervene and/or may be the user provided with relief documentation from the described system. Each selected eligible user account may be treated independently such that either or both proactive operations may be performed for the user across his/her different user accounts.

In some embodiments, the one or more proactive operations may be performed simultaneously, via parallel processing, such that deployment notifications and/or relief documentation may be generated and provided in real time or near real time. Thus, this may allow users to realize the benefits and/or protections of various user accounts in real time or near real time, and any perceived delay due to additional processes is mitigated. Additionally, simultaneous performance of the proactive operations may help avoid any benefit or protection delays for user accounts that are time sensitive. For example, a credit card user account of the user may raise the interest past the interest cap protection mandated by SCRA in an instance in which the third-party entity managing the credit card user account was not informed of the deployment of the user prior to this interest increase. While a retroactive fix may be applied to the user account, this results in a waste of computational resources and may require additional computations to the effect the improper interest increase had on the user account. Thus, it may be particularly advantageous to perform proactive operations simultaneously to improve the speed at which this documentation is generated and provided and, thereby, decrease the risk of changes being applied to a user account that conflict with benefits or protections offered during deployment.

Additionally, embodiments described herein monitor for an end-of-deployment trigger event that corresponds to an inference that the user has returned from his/her deployment. In an instance an end-of-deployment trigger event is detected, affected user accounts may be identified and an affected account resume request may be generated and provided to the user. The affected account resume request may provide the user with an indication of the user accounts that were affected by his/her deployment, such as the user accounts to which proactive operations were performed, and may inform the user of an associated status of these user accounts. The affected account resume request may request the user to provide an indication of whether he/she would like to resume one or more of the affected user accounts (e.g., resubscribe, renew, restart). Additionally, embodiments herein may proactively identify whether an affected user account still offers the original plan, offer, or configuration the user had prior to deployment and, if not, may provide the user with an indication of alternate plans, offers, or configurations. Thus, the user may interact with an affected account resume request to restart one or more desired user accounts, and the system may provide service restart requests to appropriate third-party devices on behalf of the user. Thus, the user is not required to manually determine which user accounts need to be restarted and, further, may automatically be notified of any changes to services or products offered by a third party that may affect his/her decision to restart the service.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to automatically identify a deployment status of a user and proactively perform operations for the user.

FIG. 2 illustrates a schematic block diagram of example circuitry embodying a system device that may perform various operations in accordance with some example embodiments described herein.

FIGS. 3A and 3B illustrate an example flowchart for identifying a predicted deployment event and performing proactive operations for a user, in accordance with some example embodiments described herein.

FIG. 4 illustrates an example flowchart for determining a deployment likelihood score for a predicted deployment event, in accordance with some example embodiments described herein.

FIG. 5 illustrates an example flowchart for selecting one or more eligible user accounts for the user, in accordance with some example embodiments described herein.

FIG. 6 illustrates an example flowchart for automatically providing deployment notifications to third-party devices associated with selected eligible user accounts, in accordance with some example embodiments described herein.

FIG. 7 illustrates an example flowchart for automatically generating and providing relief documentation to the user, in accordance with some example embodiments described herein.

FIGS. 8A, 8B, and 8C illustrate swim lane diagrams with example operations that may be performed by components of the environment depicted in FIG. 1, in accordance with some example embodiments described herein.

FIG. 9 illustrates an example user interface illustrating a deployment confirmation request used in some example embodiments described herein.

FIG. 10 illustrates an example user interface illustrating an affected account resume request used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers, programmable automation controllers, industrial computers, desktop computers, personal data assistants, laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as “mobile devices.”

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

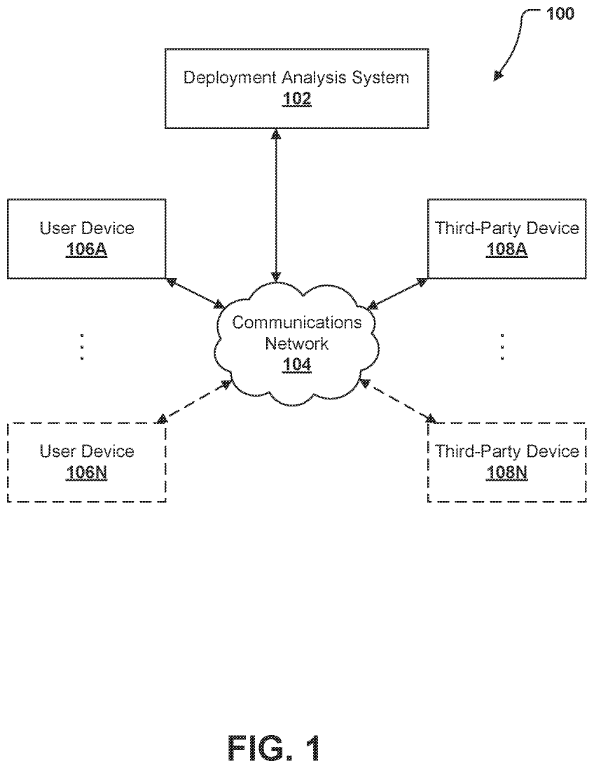

Example embodiments described herein may be implemented using any of a variety of computing devices or servers. To this end, FIG. 1 illustrates an example environment 100 within which various embodiments may operate. As illustrated, a deployment analysis system 102 may receive and/or transmit information via communications network 104 (e.g., the Internet) with any number of other devices, such as one or more of user devices 106A-106N and/or third-party devices 108A-108N.

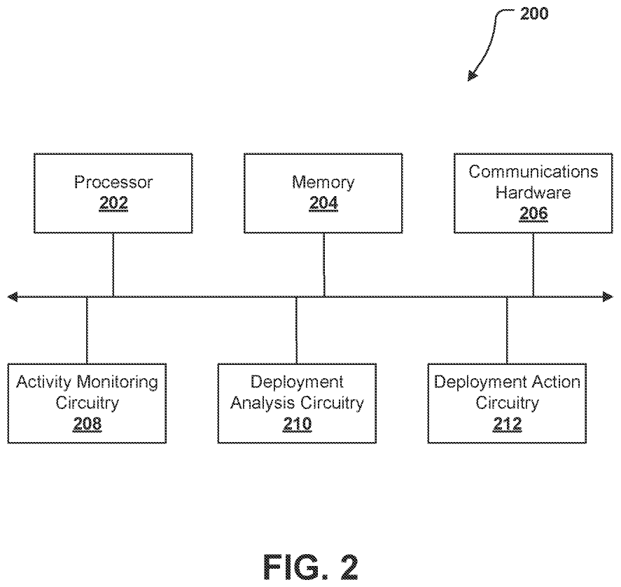

The deployment analysis system 102 may be implemented as one or more computing devices or servers, which may be composed of a series of components. Particular components of the deployment analysis system 102 are described in greater detail below with reference to apparatus 200 in connection with FIG. 2.

In some embodiments, the deployment analysis system 102 further includes a storage device that comprises a distinct component from other components of the deployment analysis system 102. The storage device may be embodied as one or more direct-attached storage devices (such as hard drives, solid-state drives, optical disc drives, or the like) or may alternatively comprise one or more network-attached storage devices independently connected to a communications network (e.g., communications network 104). The storage device may host the software executed to operate the deployment analysis system 102. The storage device may store information relied upon during operation of the deployment analysis system 102, such as various machine-learning models, user behavior data points, user account requirement sets, etc., that may be used by the deployment analysis system 102, data and documents to be analyzed using the deployment analysis system 102, or the like. In addition, the storage device may store control signals, device characteristics, and access credentials enabling interaction between the deployment analysis system 102 and one or more of the user devices 106A-106N or third-party devices 108A-108N.

The one or more user devices 106A-106N and the one or more third-party devices 108A-108N may be embodied by any computing devices known in the art. The one or more user devices 106A-106N and the one or more third-party devices 108A-108N need not themselves be independent devices, but they may be peripheral devices communicatively coupled to other computing devices. In some embodiments, one or more of the third-party devices 108A-108N may be associated with a particular third-party entity. For example, third-party devices 108A-108C may be associated with a credit bureau, third-party devices 108D-108E may be associated with a financial institution, and third-party devices 108F-108G may be associated with the Internal Revenue Service.

Although FIG. 1 illustrates an environment and implementation in which the deployment analysis system 102 interacts indirectly with a user via one or more of user devices 106A-106N and/or third-party devices 108A-108N, in some embodiments, users may directly interact with the deployment analysis system 102 (e.g., via communications hardware of the deployment analysis system 102), in which case a separate user device 106A-106N and/or third-party device 108A-108N may not be utilized. Whether by way of direct interaction or indirect interaction via another device, a user may communicate with, operate, control, modify, or otherwise interact with the deployment analysis system 102 to perform the various functions and achieve the various benefits described herein.

### Example Implementing Apparatuses

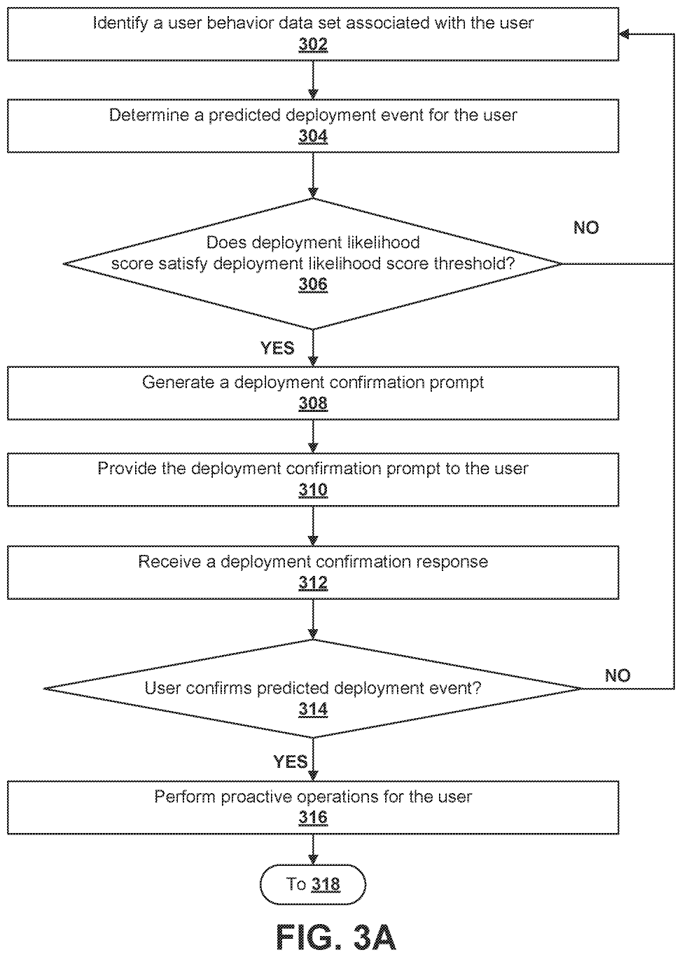

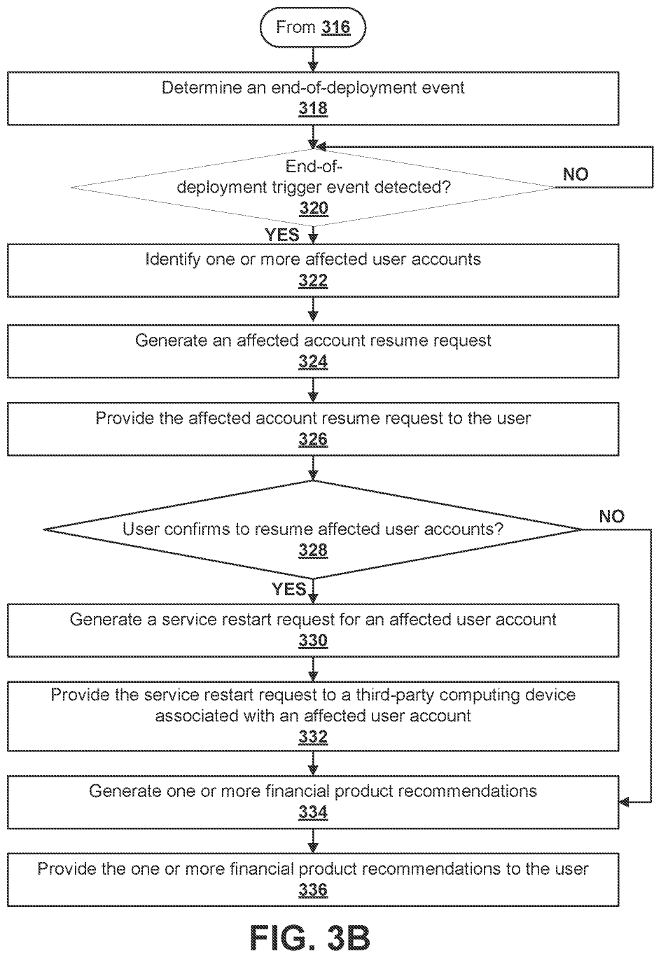

The deployment analysis system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3A-10. As illustrated in FIG. 2, the apparatus 200 may include processor 202, memory 204, communications hardware 206, activity monitoring circuitry 208, deployment analysis circuitry 210, and deployment action circuitry 212, each of which will be described in greater detail below.

The processor 202 (and/or co-processor or any other processor assisting or otherwise associated with the processor) may be in communication with the memory 204 via a bus for passing information among components of the apparatus. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor 202 may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, software instructions, or the like for enabling the apparatus 200 to carry out various functions in accordance with example embodiments contemplated herein.

The communications hardware 206 may be any means, such as a device or circuitry embodied in either hardware or a combination of hardware and software, that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In particular, in some embodiments, the communications hardware 206 may be configured to provide a deployment confirmation prompt, receive a deployment confirmation response, provide a deployment notification, provide a limited power of attorney request, provide generated relief documentation, provide a user credit inquiry authorization request, provide a credit inquiry, receive a credit report, provide a service restart request, and/or provide one or more recommended financial product recommendations. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises activity monitoring circuitry 208 that is configured to identify a user behavior data set associated with the user. In some embodiments, the activity monitoring circuitry 208 may further be configured to determine an inferred user location, identify one or more inferred associated users associated with the inferred user location, and identify a user behavior data set associated with each of the one or more inferred associated users. The activity monitoring circuitry 208 may utilize processor 202, memory 204, or any other hardware component included in the apparatus 200 to perform these operations, as described in connection with FIGS. 3A-10 below. The activity monitoring circuitry 208 may further utilize communications hardware 206 to gather data from a variety of sources (e.g., user devices 106A-106N and/or third-party devices 108A-108N, as shown in FIG. 1) and/or exchange data with a user.

In addition, the apparatus 200 further comprises a deployment analysis circuitry 210 that is configured to determine a predicted deployment event for the user. The deployment analysis circuitry 210 may utilize processor 202, memory 204, or any other hardware component included in the apparatus 200 to perform these operations, as described in connection with FIGS. 3A-10 below. The deployment analysis circuitry 210 may further utilize communications hardware 206 to gather data from a variety of sources (e.g., user devices 106A-106N and/or third-party devices 108A-108N, as shown in FIG. 1) and/or exchange data with a user.

In addition, the apparatus 200 further comprises a deployment action circuitry 212 that is configured to perform one or more proactive operations for the user. In some embodiments, the deployment action circuitry 212 may further be configured to identify one or more user behavior data points of interest from the user behavior data set, determine one or more deployment indication scores, and determine a deployment likelihood score. In some embodiments, the deployment action circuitry 212 may further be configured to train a deployment identification model. In some embodiments, the deployment action circuitry 212 may further be configured to identify one or more user accounts associated with the user, determine an eligibility category for each identified user account, and select one or more eligible user accounts. In some embodiments, the deployment action circuitry 212 may further be configured to generate a deployment notification for selected eligible user accounts. In some embodiments, the deployment action circuitry 212 may further be configured to determine a required set for a selected eligible user account. In some embodiments, the deployment action circuitry 212 may further be configured to determine a user account type for a selected eligible user account and generate relief documentation for selected eligible user accounts. In some embodiments, the deployment action circuitry 212 may further be configured to determine an end-of-deployment event, detect an end-of-deployment trigger event, identify one or more affected user accounts, and/or generate one or more financial product recommendations. The deployment action circuitry 212 may utilize processor 202, memory 204, or any other hardware component included in the apparatus 200 to perform these operations, as described in connection with FIGS. 3A-10 below. The deployment action circuitry 212 may further utilize communications hardware 206 to gather data from a variety of sources (e.g., user devices 106A-106N and/or third-party devices 108A-108N, as shown in FIG. 1) and/or exchange data with a user.

Although components 202-212 are described in part using functional language, it will be understood that the particular implementations necessarily include the use of particular hardware. It should also be understood that certain of these components 202-212 may include similar or common hardware. For example, the activity monitoring circuitry 208, deployment analysis circuitry 210, and deployment action circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the activity monitoring circuitry 208, deployment analysis circuitry 210, and deployment action circuitry 212 may leverage processor 202, memory 204, or communications hardware 206 as described above, it will be understood that any of activity monitoring circuitry 208, deployment analysis circuitry 210, and deployment action circuitry 212 may include one or more dedicated processor, specially configured field programmable gate array, or application-specific interface circuit to perform its corresponding functions and may accordingly leverage processor 202 executing software stored in a memory (e.g., memory 204) or communications hardware 206 for enabling any functions not performed by special-purpose hardware. In all embodiments, however, it will be understood that activity monitoring circuitry 208, deployment analysis circuitry 210, and deployment action circuitry 212 comprise particular machinery designed for performing the functions described herein in connection with such elements of the apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces (each, a GUI) and flowcharts.

### Example Operations

FIGS. 3A-7 illustrate example flowcharts that contain example operations implemented by example embodiments described herein. The operations illustrated in FIGS. 3A-7 may, for example, be performed by a system device of the deployment analysis system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, activity monitoring circuitry 208, deployment analysis circuitry 210, deployment action circuitry 212, and/or any combination thereof. It will be understood that user interaction with the deployment analysis system 102 may occur directly via communications hardware 206, or may instead be facilitated by a separate user device 106A-106N or third-party device 108A-108N, as shown in FIG. 1, and may have similar or equivalent physical componentry facilitating such user interaction.

Turning first to FIGS. 3A-3B, example operations are shown for identifying a predicted deployment event and performing proactive operations for a user. The predicted deployment event may be indicative of whether the user is currently deployed, or may become deployed shortly, without requiring the user to explicitly notify the system, thereby reducing the manual burden on the user. The predicted deployment event may be determined using a deployment identification machine-learning model trained to detect patterns within a user behavior data set, and generate a deployment likelihood score. In an instance in which the deployment likelihood score satisfies a deployment likelihood score threshold, the user may be presented with a deployment confirmation prompt, requesting the user to confirm or deny the predicted deployment event. If the user confirms the predicted deployment event, proactive operations, such as deployment notifications and/or relief documentation, may then be performed for the user. The particular operations performed may be based on the preferences of the user and based on the user accounts associated with the user. In some embodiments, proactive operations may be performed simultaneously, via parallel processing, such that deployment notifications and/or relief documentation may be generated and provided in real time or near real time. Thus, this may allow users to realize the benefits and/or protections of various user accounts in real time or near real time and any perceived delay due to additional processes is mitigated. This processing further may improve the speed at which this documentation is generated and provided, thereby decreasing the risk of changes being applied to a user account that conflict with benefits or protections offered during deployment.

As shown by operation 302, the apparatus 200 includes means, such as processor 202, memory 204, communications hardware 206, activity monitoring circuitry 208, or the like, for identifying a user behavior data set associated with the user. A user behavior set may include a plurality of user behavior data points, which may be collected and/or received from various devices, such as any one of user devices 106A-106N, third-party devices 108A-108N, and/or devices associated with the deployment analysis system 102. A user behavior data point may describe information pertaining to the user. For example, user behavior data points may include, but are not limited to, transactions, financial activity (e.g., transfers, withdrawals, and deposits), location data, device usage data, browsing history, and/or the like. Each user behavior data point may be associated with metadata, such as the time and/or date the user behavior data point was created, associated location data, the device that provided the user behavior data point, a data type (e.g., transaction, withdrawal, deposit, transfer, and/or the like), etc. In some embodiments, the activity monitoring circuitry 208 may be configured to periodically or semi-periodically identify a user behavior data set associated with the user.

The activity monitoring circuitry 208 may collect and/or identify user behavior data points and append these data points to the user behavior data set. In some embodiments, the activity monitoring circuitry 208 may directly request user behavior data points from a device, such as any one of user devices 106A-106N. Alternatively, communications hardware 206 may receive user behavior data points from devices, such as any one of user devices 106A-106N, third-party devices 108A-108N, and/or devices associated with the deployment analysis system 102. In some embodiments, the activity monitoring circuitry 208 may query associated storage repositories and/or internal user accounts associated with the deployment analysis system 102 to identify stored user behavior data pertaining to the user. The activity monitoring circuitry 208 may then append the stored user behavior data points to the user behavior data set.

In some embodiments, the activity monitoring circuitry 208 may access a user profile, which may be stored and/or maintained in memory 204 or another repository, to determine user behavior data points. A user profile may correspond to a user and may include an indication of one or more user accounts associated with the user. The one or more associated user accounts may each include user behavior data points, such as transactions and associated metadata. For example, deployment analysis system 102 may be associated with a financial institution and the user profile may include a checking user account, savings user account, credit user account, etc. Additionally, user behavior data points, such as transactions, may be included in a user account and may therefore provide an indication of another user account offered by a third party that is also associated with the user. A user profile may be associated with a user identifier that is unique to the user such that a user identifier for a user may be used to find the corresponding user profile for a particular user. Additionally, the user profile may include one or more user parameters corresponding to the user, such as a user name (e.g., first name, last name, middle name, and/or middle initial), a physical address, an email address, a phone number, associated device information, device identification numbers, and/or the like. The user profile may further include an indication of a service status of the user. A service status of the user may include an active-duty, deployed, veteran, or non-veteran service status. In some embodiments, the activity monitoring circuitry 208 may determine the periodic or semi-periodic time frame for identifying a user behavior data set associated with the user based on a service status of a user. For example, the activity monitoring circuitry 208 may determine a periodic time frame of one week for a user associated with an active-duty service status but may determine a periodic time frame of one month for a user associated with a non-veteran service status. Thus, the activity monitoring circuitry 208 may conserve computational resources by prioritizing users who have a higher likelihood of deployment over users with lower likelihoods of deployment.

As shown by operation 304, the apparatus 200 includes means, such as processor 202, memory 204, communications hardware 206, deployment analysis circuitry 210, or the like, for determining a predicted deployment event for the user. A predicted deployment event may correspond to a current or upcoming predicted deployment for a user. The predicted deployment event may include a deployment likelihood score and a time period of interest. The deployment likelihood score may be indicative of a likelihood that the user is deployed during the time period of interest. The predicted deployment event may then be evaluated to determine whether to provide the user with a deployment confirmation prompt.

In some embodiments, the deployment analysis circuitry 210 may use a deployment identification machine-learning model to determine the predicted deployment event. The deployment identification machine-learning model may be a neural network configured to identify patterns within a user behavior data set that may serve as indications that a user may be deployed and, further, use these indicators to generate a deployment likelihood score for the user. The deployment identification machine-learning model may process a given user behavior data set and generate a deployment likelihood score for a user for a time period of interest.

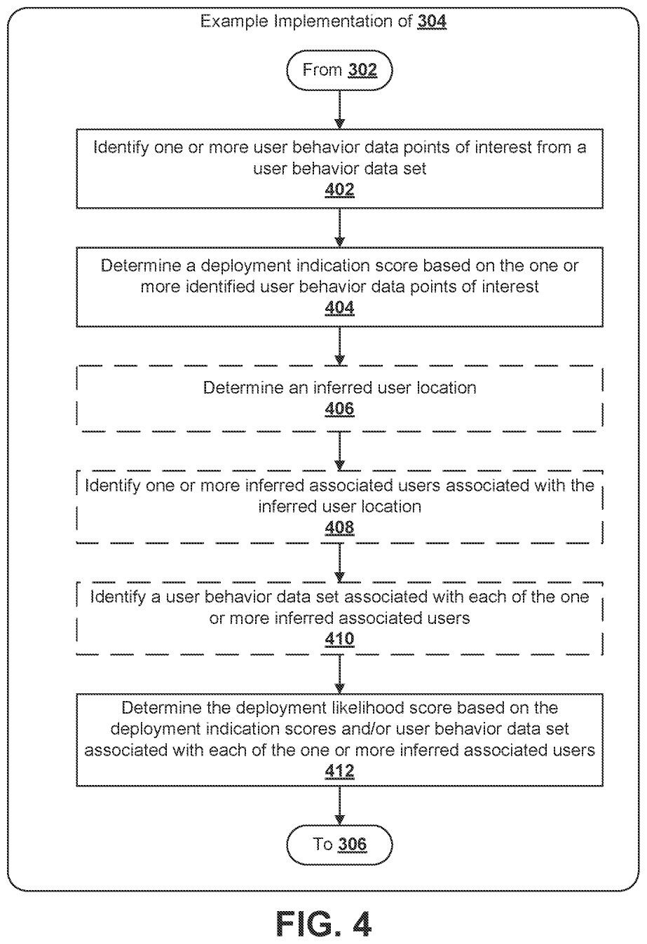

In some embodiments, the deployment identification machine-learning model may be trained using user behavior training data sets that are labeled to indicate whether a corresponding user is deployed or not deployed. The deployment identification machine-learning model may identify common features (e.g., user behavior data points) among the user behavior training data set that indicate deployment. For example, the deployment identification machine-learning model may determine that user behavior data points corresponding to transactions at commissaries associated with a foreign military base are a strong indicator that a user is currently deployed. As another example, a user behavior data point corresponding to a cancellation fee for a subscription-based user account may be a weak indicator that a user is currently deployed. Additionally, the deployment identification machine-learning model may be trained to identify relationships or lack of relationships between certain types of user behavior data points, which may aid in determination of deployment. For example, the deployment identification machine-learning model may be trained to recognize that a user behavior training data set that includes user behavior data points corresponding to foreign transactions and airplane ticket purchases to a nearby location is not a strong indication of deployment. However, a user behavior training data set that includes user behavior data points corresponding to foreign transactions without an airplane ticket purchase is a strong indication of deployment. This may help the deployment identification machine-learning model distinguish planned user trips from deployments. Additionally, the deployment identification machine-learning model may be trained to eliminate or ignore unimportant features (e.g., user behavior data points) that may be common among all user behavior data, regardless of deployment status. For example, a user behavior data point corresponding to a payment for a car loan user account may be common among deployed users and non-deployed users. Furthermore, the deployment identification machine-learning model may be trained to determine whether certain changes in behavioral patterns of a user are indicative of a deployment. For example, the user behavior training data set may indicate the user has historically paid monthly gym membership fees for a gym membership user account but has not paid the gym membership fee this month, and this change may be an indication of a deployment. As will be discussed in further detail in FIG. 4, the deployment identification machine-learning model may infer the relative strength of these user behavior data points and assign various deployment indication scores to user behavior data points. The various deployment indication scores may then be used to determine the deployment likelihood score.

The deployment identification machine-learning model may also be trained to determine a time period of interest for a deployment. In some embodiments, the user behavior training data sets include both pre-deployment user behavior data points and post-deployment user behavior data points, and are labeled such that the date or occurrence of the deployment is known. Thus, the deployment identification machine-learning model may determine whether the user behavior data set is indicative of a deployment and, further, when the deployment is predicted to occur. For example, a user behavior data set that includes user behavior data points that correspond to foreign transactions may indicate the time period of interest is the current date, whereas a user behavior data set that includes user behavior data points corresponding to cancellation of service fees for user accounts may indicate a time period of interest of deployment within the next month.

In some embodiments, operation 304 may be performed in accordance with the operations described by FIG. 4. Turning now to FIG. 4, example operations are shown for a deployment likelihood score for a predicted deployment event.

As shown by operation 402, the apparatus 200 includes means, such as processor 202, memory 204, communications hardware 206, deployment analysis circuitry 210, or the like, for identifying one or more user behavior data points of interest from a user behavior data set. The deployment analysis circuitry 210 may first identify user behavior data points of interest from the user behavior data set. In some embodiments, the deployment analysis circuitry 210 may identify user behavior data points based on the associated metadata indicative of the time and/or date the user behavior data point was created. In particular, the deployment analysis circuitry 210 may identify only user behavior data points that were generated within a particular time window as user behavior data points of interest. For example, the deployment analysis circuitry 210 may only identify user behavior data points that occurred within the last year as user behavior data points of interest. As such, the deployment analysis circuitry 210 may allow the user behavior data set to long-term user behavior pattern trends while also ensuring the user behavior data points are up to date. The time window used by the deployment analysis circuitry 210 may be configured by one or more authorized end users (e.g., user associated with the deployment analysis system 102) and/or may be determined based on output from the deployment identification machine-learning model. For example, the deployment identification machine-learning model may determine that user behavior data points generated up to one year and six months ago may be used, and thus, the time window may be one year and six months to provide all relevant user behavior data points to the deployment identification machine-learning model.

In some embodiments, the deployment analysis circuitry 210 may further identify user behavior data points based on the corresponding data type. In particular, deployment analysis circuitry 210 may select only user behavior data points corresponding to data types determined to be relevant by the deployment identification machine-learning model. As described above, the deployment identification machine-learning model may be trained to identify user behavior data points that are indicators of a user deployment. The magnitude of the indication of these user behavior data points may be provided by a deployment indication score for an associated user behavior data point. Thus, in some embodiments, the deployment analysis circuitry 210 may identify user behavior data points that correspond to data types associated with deployment indications scores that satisfy a deployment indication score threshold. Alternatively, the deployment analysis circuitry 210 may only exclude user behavior data points that are classified by the deployment identification machine-learning model as not being relevant to deployment indications. This may prevent the exclusion of user behavior data points that may individually score poorly but contribute to a pattern of behavior of other user behavior data points that is indicative of deployment.

As shown by operation 404, the apparatus 200 includes means, such as processor 202, memory 204, communications hardware 206, deployment analysis circuitry 210, or the like, for determining a deployment indication score based on the one or more identified user behavior data points of interest. Once the deployment analysis circuitry 210 has identified the one or more user behavior data points of interest, the deployment analysis circuitry 210 may determine a deployment indication score for identified user behavior data points of interest. In particular, the deployment analysis circuitry 210 may provide the identified user behavior data points of interest to the deployment identification machine-learning model, which may be configured to determine the deployment indication score based on the provided user behavior data points.

As described above, the deployment identification machine-learning model may be trained to infer a relative strength of particular user behavior data points as an indicator of a user's deployment. Said otherwise, the deployment indication score may be indicative of a relative correlation of a particular user behavior data point with a user's deployment. For example, the deployment indication score may be associated with a numerical range, such as between 0 and 1, where 0 is indicative of no correlation between the user behavior data point and deployment and 1 is indicative of absolute correlation between the user behavior data point and deployment (e.g., if this user behavior data point is present, the user is known to be deployed). The deployment identification machine-learning model may determine relative deployment indication scores for each identified user behavior data point within this numerical range.

In some embodiments, the deployment identification machine-learning model may further determine a deployment indication score for combinations of user behavior data points of interest. As discussed above, the deployment identification machine-learning model may be trained to identify relationships between certain types of user behavior data points, which may aid in determination of deployment. These combinations of user behavior data points may be associated with a deployment indication score inferred during training of the deployment identification machine-learning model.

In some embodiments, the deployment identification machine-learning model may further determine a deployment indication score for changes in user behavior data points of interest. As discussed above, the deployment identification machine-learning model may be trained to detect changes in user behavior, which may aid in determination of deployment. These changes in user behavior may be inferred by monitoring user behavior data points. A user behavior change may be associated with a deployment indication score inferred during training of the deployment identification machine-learning model.

Optionally, as shown by operation 406, the apparatus 200 includes means, such as processor 202, memory 204, communications hardware 206, deployment analysis circuitry 210, or the like, for determining an inferred user location. An inferred user location may describe a geographic location or geographic range (e.g., zone, town, city, province, state, country) that a user is inferred to currently occupy. In some embodiments, the deployment analysis circuitry 210 may be configured to determine an inferred user location. The deployment analysis circuitry 210 may determine an inferred user location based on the user behavior data set. In particular, the deployment analysis circuitry 210 may determine an inferred user location using a most recent user behavior data point that is associated with metadata that includes location data. For example, a user behavior data point corresponding to a transaction at a foreign military base may be associated with location metadata indicating the transaction occurred at the foreign military base and occurred one hour ago. The deployment analysis circuitry 210 may determine the location of the foreign military base via an online query, a location database query, and/or the like. Thus, the deployment analysis circuitry 210 may determine an inferred user location of the location of the foreign military base for the user.

Optionally, as shown by operation 408, the apparatus 200 includes means, such as processor 202, memory 204, communications hardware 206, deployment analysis circuitry 210, or the like, for identifying one or more inferred associated users associated with the inferred user location. In some embodiments, the deployment analysis circuitry 210 may perform operation 404 for other users such that deployment analysis circuitry 210 may identify an inferred user location for other users. The deployment analysis circuitry 210 may use the inferred user location determined for the other users to identify one or more inferred associated users from the one or more other users based on an associated inferred user location. Said otherwise, the deployment analysis circuitry 210 may determine other users who are nearby or within the same inferred user location as the user and may identify these other users as inferred associated users. For example, these inferred associated users may be other service members who are deployed in the same area as the user. The determinations of other users who may also be deployed aid in determining a likelihood that a user is deployed and may aid in distinguishing between when a user is travelling versus when a user is actively deployed. As such, it may be advantageous for the deployment analysis circuitry 210 to consider other user data when determining a deployment likelihood score for the user. Other users who are likely to be deployed with the user are likely to be associated with the same or a nearby location as the user.

Optionally, as shown by operation 410, the apparatus 200 includes means, such as processor 202, memory 204, communications hardware 206, deployment analysis circuitry 210, or the like, for identifying a user behavior data set associated with each of the one or more inferred associated users. Once the one or more inferred associated users are identified, a user behavior data set may be identified for each associated user. The user behavior data set for each identified associated user may identified substantially similarly to the user behavior data set for the user as described in operation 302 of FIG. 3. In some embodiments, the deployment analysis circuitry 210 may provide the user behavior data sets associated with the inferred associated users to the deployment identification machine-learning model such that the deployment identification machine-learning model may determine a deployment likelihood score for the user based in part on the one or more inferred associated users.

As shown by operation 412, the apparatus 200 includes means, such as processor 202, memory 204, communications hardware 206, deployment analysis circuitry 210, or the like, for determining a deployment likelihood score based on the deployment indication scores and/or a user behavior data set associated with each of the one or more inferred associated users. In some embodiments, the deployment analysis circuitry 210 may further determine the deployment likelihood score based on the user behavior data set associated with each of the one or more inferred associated users. The deployment analysis circuitry 210 may use the deployment identification machine-learning model to determine the deployment likelihood score for the user. In some embodiments, the deployment likelihood score is a numerical value that is indicative of a likelihood that a user is deployed. Unlike deployment indication scores, the deployment likelihood score may not have a particular range, and instead, the value of the deployment likelihood score may be based on the number of identified user behavior data points, the number of deployment indication scores determined, and the magnitude of the deployment indication scores.

In some embodiments, the deployment identification machine-learning model may determine the deployment likelihood score for the user based on the deployment indication scores determined based on the one or more identified user behavior points of interest. In particular, the deployment identification machine-learning model may perform one or more mathematical and/or logical operations on the deployment indication scores to determine a deployment likelihood score. For example, the deployment identification machine-learning model may sum all the deployment indication scores to determine a deployment likelihood score. As another example, the deployment identification machine-learning model may take a weighted average of the deployment indication scores to determine a deployment likelihood score.

In some embodiments, the deployment identification machine-learning model may additionally determine a deployment indication score for the one or more inferred associated users based on respective associated user behavior data sets in a similar fashion to operations 402-404 described above and, further, determine a deployment likelihood score for each inferred associated user similarly as described above. In some embodiments, the deployment identification machine-learning model may include a supplemental value for the user and the one or more inferred associated users when determining the deployment likelihood score for the respective user. In particular, the deployment identification machine-learning model may first determine an initial deployment likelihood score for the user and the inferred associated users, determine whether the initial deployment likelihood score satisfies one or more score thresholds, and, depending on which score threshold the initial deployment likelihood score satisfies, may determine a supplemental value for the user that may be treated as a deployment indications score. The deployment identification machine-learning model may then update the initial deployment likelihood score for the user and the inferred associated users to reflect this supplemental value and determine a current deployment likelihood score. As such, the deployment identification machine-learning model may use other inferred associated user data to help confirm the user is deployed, thereby increasing the accuracy of the deployment identification machine-learning model.

Returning now to FIG. 3A, as shown by operation 306, the apparatus 200 includes means, such as processor 202, memory 204, communications hardware 206, deployment analysis circuitry 210, or the like, for determining whether the deployment likelihood score of the predicted deployment event satisfies a deployment likelihood score threshold. Once the deployment analysis circuitry 210 has determined the predicted deployment event for the user, the deployment analysis circuitry 210 may determine whether the deployment likelihood score included in the predicted deployment event satisfies a deployment likelihood score threshold. The deployment likelihood score threshold may define a value and/or condition the deployment likelihood score must satisfy. The deployment likelihood score threshold value may be configured by one or more authorized user, such as an end user associated with an entity that operates the deployment analysis system 102.

By way of example, the deployment analysis circuitry 210 may determine whether a deployment likelihood score is greater than or equal to a value described by the deployment likelihood score threshold, and in an instance in which the deployment likelihood score is greater than or equal to the value, the deployment analysis circuitry 210 may determine the deployment likelihood score satisfies the deployment likelihood score threshold. Otherwise, the deployment analysis circuitry 210 may determine the deployment likelihood score fails to satisfy the deployment likelihood score threshold.

In an instance in which the deployment likelihood score fails to satisfy the deployment likelihood score threshold, the process proceeds back to operation 302. In an instance in which the deployment likelihood score fails to satisfy the deployment likelihood score threshold, this may indicate that there is not sufficient evidence (e.g., obtained via the user behavior data set) to determine whether the user is deployed or not. Thus, the process may proceed back to operation 302, where the user behavior data set may be updated to include recent user behavior data points. The process may then be repeated and a new deployment likelihood score may be determined for the user based on the updated user behavior data set. This process may be repeated until a deployment likelihood score for the user is determined to satisfy the deployment likelihood score threshold.

In an instance in which the deployment likelihood score satisfies the deployment likelihood score threshold, the process proceeds to operation 308. As shown by operation 308, the apparatus 200 includes means, such as processor 202, memory 204, communications hardware 206, deployment analysis circuitry 210, or the like, for generating a deployment confirmation prompt. In an instance in which the deployment likelihood score satisfies the deployment likelihood score threshold, this may indicate there is sufficient evidence (e.g., obtained via the user behavior data set) to infer the user is deployed. Once the deployment analysis circuitry 210 has determined the deployment likelihood score satisfies the deployment likelihood score threshold such that the user is inferred to be deployed, the deployment analysis circuitry 210 may generate a deployment confirmation prompt for the user. The deployment confirmation prompt may request the user to confirm or deny the predicted deployment event. Thus, the confirmation prompt may confirm or deny whether the user is deployed, and the system may take further action based on this confirmation or denial. The deployment confirmation prompt may include one or more user interaction elements that allow the user to interact with the deployment confirmation prompt to confirm or deny the predicted deployment event.

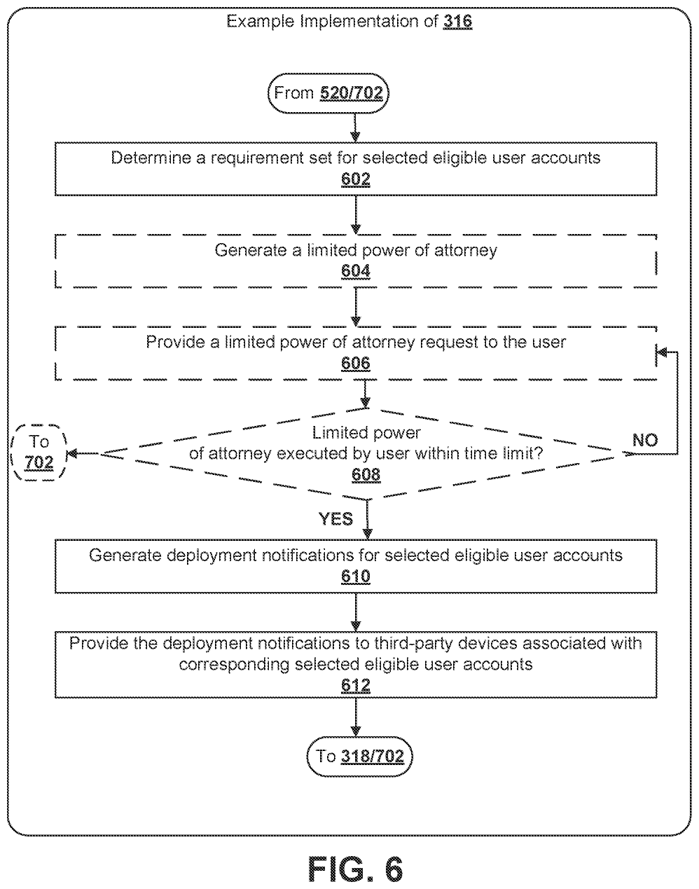

In some embodiments, the deployment confirmation prompt may further include a request for the user to provide confirmation documentation. Confirmation documentation may include proof or evidence that may serve to validate a user's deployment. Confirmation documentation may include deployment orders such as a Department of Defense 220 (DD220) form. As described in further detail below with respect to FIG. 6, confirmation documentation may be required by particular entities in order for the user to realize the full benefits offered by the respective entity. Thus, the deployment analysis circuitry 210 may generate the deployment confirmation prompt to include a request for the confirmation documentation in an instance a user confirms he/she is deployed. The deployment confirmation prompt may further include one or more user interaction elements that allow the user to interact with the deployment confirmation prompt to provide the confirmation documentation.

As shown by operation 310, the apparatus 200 includes means, such as processor 202, memory 204, communications hardware 206, or the like, for providing the deployment confirmation prompt to the user. Once the deployment analysis circuitry 210 has generated the deployment confirmation prompt, communications hardware 206 may provide the deployment confirmation prompt to the user. In particular, the communications hardware 206 may provide the deployment confirmation prompt to any one or more of user devices 106A-106N. In some embodiments, the communications hardware 206 may determine user devices 106A-106N using a user profile associated with the user. The user profile may pertain to the particular user and include associated user devices (e.g., user devices 106A-106N) and device information, such as phone numbers, identification numbers, serial numbers, international mobile equipment identity numbers, etc.

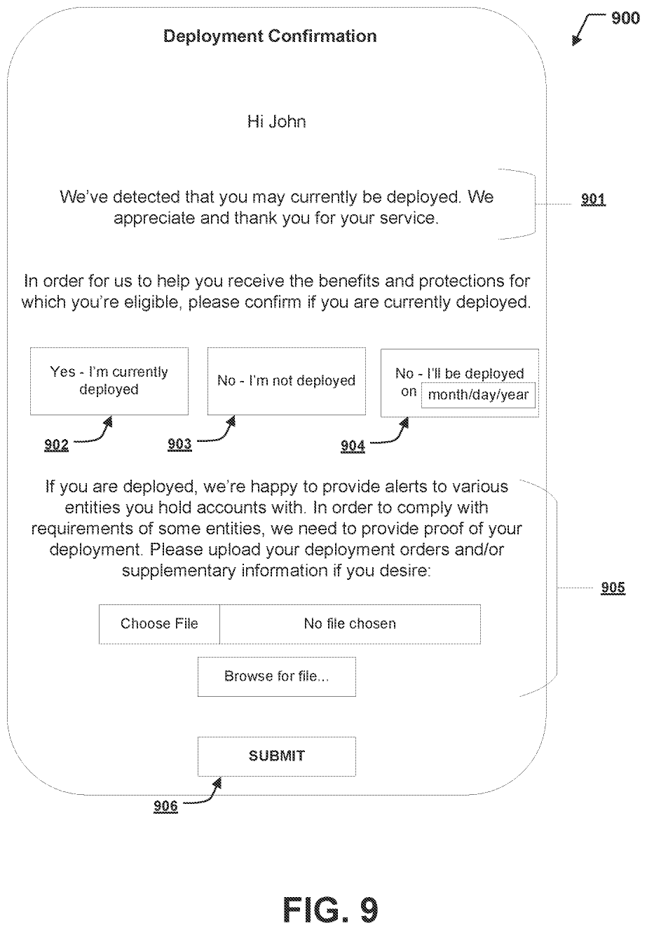

Turning to FIG. 9, a GUI is provided that illustrates an example deployment confirmation prompt. As noted previously, a user may interact with the deployment analysis system 102 by directly engaging with communications hardware 206 of an apparatus 200 comprising a system device of the deployment analysis system 102. In such an embodiment, the GUI shown in FIG. 9 may be displayed to a user by the apparatus 200. Alternatively, a user may interact with the deployment analysis system 102 using a separate user device (e.g., any of user devices 106A-106N, as shown in FIG. 1), which may communicate with the deployment analysis system 102 via communications network 104. In such an embodiment, the GUI shown in FIG. 9 may be displayed to the user by the user device.

As shown in FIG. 9, the deployment confirmation prompt 900 may include an indication of the time period of interest 901 pertaining to the deployment. The deployment confirmation prompt 900 may also include user interaction elements 902, 903, and 904. The user may interact with (e.g., click, select, touch, audibly request) element 902 to confirm the deployment, element 903 to deny the deployment, or element 904 to correct a time period of interest for the predicted deployment event. Additionally, the deployment confirmation prompt 900 may further include a request for confirmation documentation. The deployment confirmation prompt 900 may include interaction element 905 that allows the user to upload, attach, or otherwise provide access to confirmation documentation. The deployment confirmation prompt 900 may further include user interaction element 906 that allows the user to submit his/her responses as a deployment confirmation response to communications hardware 206.

Returning now to FIG. 3A, as shown by operation 312, the apparatus 200 includes means, such as processor 202, memory 204, communications hardware 206, or the like, for receiving a deployment confirmation response. The communications hardware 206 may receive a deployment confirmation response from the user via one or more user devices 106A-106N. The deployment confirmation response may include an indication of whether the user confirmed or denied the predicted deployment event. The deployment confirmation response may further include confirmation documentation (e.g., a DD220 form) from the user. The communications hardware 206 may store the deployment confirmation response in an associated user profile.

In some embodiments, in an instance in which the user does not respond to the deployment confirmation prompt within a responsive time window (e.g., within one day, one week, and/or the like), the deployment confirmation response may timeout and a deployment confirmation response may automatically be generated and received by the communications hardware. The received deployment confirmation response may indicate the user failed to respond to the deployment confirmation prompt within the responsive time window. Thus, the deployment confirmation response may indicate the user failed to confirm the predicted deployment event. In some embodiments, a failure to confirm a predicted deployment event may be treated as a denial of the predicted deployment event.

In some embodiments, the deployment confirmation response may be used to retrain the deployment identification machine-learning model. In particular, the deployment identification machine-learning model may use the confirmation or denial of the predicted deployment event as a basis for reinforcement learning such that the deployment identification machine-learning model may fine-tune user behavior data points of interest and associated deployment indication scores. Thus, the deployment confirmation response provided by the user may allow the deployment identification machine-learning model to improve the accuracy of determining a deployment likelihood score for a user.

As shown by operation 314, the apparatus 200 includes means, such as processor 202, memory 204, communications hardware 206, deployment action circuitry 212, or the like, for determining whether the user confirms the predicted deployment event. The deployment action circuitry 212 may process the deployment confirmation response to determine whether the user confirmed the predicted deployment event, denied the predicted deployment event, or modified the predicted deployment event. In an instance in which the deployment confirmation response indicates the user modified the predicted deployment event, such as changing the time period of interest, the deployment action circuitry 212 may automatically update the predicted deployment event to reflect this modification.

In an instance in which the user denies or fails to confirm the predicted deployment event, the process may proceed back to operation 302, where the user behavior data set may be updated to include recent user behavior data points. The process may then be repeated and a new deployment likelihood score may be determined for the user based on the updated user behavior data set. This process may be repeated until a deployment likelihood score for the user is determined to satisfy the deployment likelihood score threshold. In some embodiments, the process may be suspended for a period of time (e.g., the next 90 days) because the user denied the predicted deployment event.

In an instance in which the user confirmed the predicted deployment event, the process may proceed to operation 316. As shown by operation 316, the apparatus 200 includes means, such as processor 202, memory 204, communications hardware 206, deployment action circuitry 212, or the like, for performing one or more proactive operations for the user. The deployment action circuitry 212 may determine the one or more proactive operations to be performed for the user based on user account types associated with the user as well as user preferences indicated by a corresponding user profile. In some embodiments, the deployment action circuitry 212 may automatically generate and provide deployment notifications to third-party entities managing user accounts such that the third-party entity is made aware of the user's deployment status and the user may receive the benefits and protections without manually needing to request these benefits and/or protections. Additionally or alternatively, the deployment action circuitry 212 may automatically generate relief documentation for third-party entities managing user accounts and provide this relief documentation to the user to provide to the respective third party. In some instances, a third-party entity may be inaccessible or otherwise unreachable by apparatus 200 or the user may prefer to provide the relief documentation himself/herself. As such, the deployment action circuitry 212 may determine to generate the relief documentation that includes user information and is indicative of the deployment of the user and provide this relief documentation to the user. Thus, the user does not need to prepare this relief documentation himself/herself, and instead, he/she may simply provide the relief documentation generated by the deployment action circuitry 212.

The particular proactive operations performed by the deployment action circuitry 212 may be determined based on the user account type of the user account and user preferences described by a user profile of the user. User preferences may be indicative of user preferences for particular user accounts or user account types with respect to how an entity associated with the particular user account should be informed of the deployment event. Thus, the user preferences allow the user to control what proactive operations are performed for individual user accounts. For example, the deployment action circuitry 212 may determine user preferences indicate that the user prefers automatic deployment notifications for a particular user account or particular user account type. Thus, the deployment action circuitry 212 may determine the proactive operations to perform for a user account based on the corresponding user account type and user preferences. The deployment action circuitry 212 may determine user preferences of the user by accessing a corresponding user profile of the user and identifying user preferences described by the user profile. In some embodiments, users may indicate user preferences when opening a user account with the entity associated with deployment analysis system 102 and/or may update user preferences at any time. In some embodiments, user preferences of a user may be set to a default configuration if no input is received from the user. For example, a default configuration may set default proactive operations (e.g., automatic deployment notifications or relief documentation) for certain user accounts or user account types.

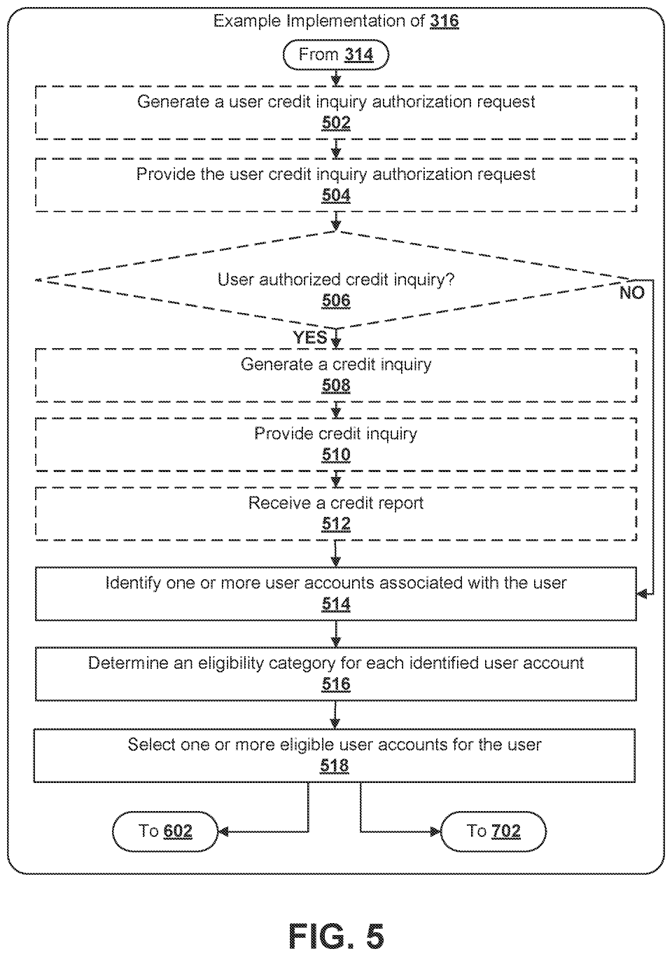

In some embodiments, operation 316 may be performed in accordance with the operations described by FIGS. 5-7. Turning first to FIG. 5, example operations are shown for selecting one or more eligible user accounts for the user. Prior to performing the one or more proactive operations for the user, the deployment action circuitry 212 may first select eligible user accounts for the user for which the proactive operations will be performed. In particular, the deployment action circuitry 212 may select only user accounts that are eligible to receive benefits or protections from deployed user status and/or are user accounts the user would be interested in receiving benefits and/or protections for. Thus, the deployment action circuitry 212 may limit the number of user accounts for which proactive actions may be performed for to only eligible user accounts of interest to the user, thereby improving computational efficiency of the apparatus 200 and reducing overall network bandwidth usage.

Optionally, as shown by operation 502, the apparatus 200 includes means, such as processor 202, memory 204, communications hardware 206, deployment action circuitry 212, or the like, for generating a user credit inquiry authorization request. In some embodiments, the deployment action circuitry 212 may generate a user credit inquiry authorization request for the user. The user credit inquiry authorization request may request the user to authorize the deployment action circuitry 212 to perform a credit inquiry of the user. In some embodiments, the user credit inquiry may be a request for a soft inquiry (e.g., soft credit check or soft credit pull). The deployment action circuitry 212 may request a credit inquiry for the user to aid the deployment action circuitry 212 with identifying all user accounts for the user rather than just user accounts held with and/or accessible to apparatus 200 and/or deployment analysis system 102. The user credit inquiry authorization request may include one or more interaction elements that allow the user to interact with the credit inquiry authorization request to authorize or deny the deployment action circuitry 212 to perform the credit inquiry.

Optionally, as shown by operation 504, the apparatus 200 includes means, such as processor 202, memory 204, communications hardware 206, or the like, for providing the user credit inquiry authorization request to the user. Once the deployment action circuitry 212 has generated the credit inquiry authorization request, communications hardware 206 may provide the credit inquiry authorization request to the user. In particular, the communications hardware 206 may provide the user credit inquiry authorization request to any one or more of user devices 106A-106N. In some embodiments, the communications hardware 206 may determine user devices 106A-106N using a user profile associated with the user. The user profile may pertain to the particular user and include associated user devices (e.g., user devices 106A-106N) and device information, such as phone numbers, identification numbers, serial numbers, international mobile equipment identity numbers, etc.

Optionally, as shown by operation 506, the apparatus 200 includes means, such as processor 202, memory 204, communications hardware 206, deployment action circuitry 212, or the like, for determining whether the user affirmatively authorized a credit inquiry. In some embodiments, the communications hardware 206 may receive a user credit inquiry authorization response from the user via one or more user devices 106A-106N. The credit inquiry authorization response may include an indication of whether the user authorized or denied the deployment action circuitry 212 to perform a credit inquiry for the user. In some embodiments, in an instance in which the user does not respond to the credit inquiry authorization request within a responsive time window (e.g., within one day, one week, and/or the like), the credit inquiry authorization request may time out and a credit inquiry authorization response may automatically be generated and received by the communications hardware 206. The received credit inquiry authorization response may indicate the user failed to respond to the credit inquiry authorization request within the responsive time window. Thus, the credit inquiry authorization response may indicate the user failed to authorize the credit inquiry. A failure to authorize a credit inquiry may be treated as a denial of the credit inquiry.

In an instance in which the user fails to affirmatively authorize the credit inquiry, the process may proceed to operation 514. The process may thus skip over subsequent steps of obtaining a credit report for the user and using the credit report to identify the one or more user accounts associated with the user.

In an instance in which the user is determined to have affirmatively authorized the credit inquiry, the process may proceed to operation 508. Optionally, as shown by operation 508, the apparatus 200 includes means, such as processor 202, memory 204, communications hardware 206, deployment action circuitry 212, or the like, for generating a credit inquiry. Once the deployment action circuitry 212 has determined the user has authorized the credit inquiry, the deployment action circuitry 212 may generate a credit inquiry. The deployment action circuitry 212 may determine an associated user profile to generate the credit inquiry. The deployment action circuitry 212 may use user parameters included in the user profile such as the user's name, address, etc. In some embodiments, the deployment action circuitry 212 may use additional user parameters, such as a user's social security number, date of birth, or other personal identifiable information. The credit inquiry may further include a request for a credit report that includes user accounts associated with the user.

Optionally, as shown by operation 510, the apparatus 200 includes means, such as processor 202, memory 204, communications hardware 206, or the like, for providing the credit inquiry. Once the deployment action circuitry 212 has generated the credit inquiry, communications hardware 206 may provide the credit inquiry to one or more third-party devices, such as any one or more of third-party devices 108A-108N, which are associated with a credit agency. In some embodiments, the communications hardware 206 may determine third-party devices 108A-108N using an entity repository. The entity repository may include an entity profile for one or more third-party entities. The entity profile may include information about the entity (e.g., type of entity, entity size, age, and/or the like) as well as third-party devices associated with a respective third-party entity. The communications hardware 206 may use the corresponding entity profile in an entity repository to identify the appropriate third-party devices 108A-108N to provide the credit inquiry to. In some embodiments, the entity repository may designate certain third-party entities and/or respective third-party devices as the entity that should receive a credit inquiry. As such, the communications hardware 206 may determine the third-party entity to provide the credit inquiry to.

Optionally, as shown by operation 512, the apparatus 200 includes means, such as processor 202, memory 204, communications hardware 206, or the like, for receiving a credit report. In response to providing the credit inquiry to a third-party device associated with a third-party entity, the communications hardware 206 may receive a credit report from the third-party entity via a third-party device, such as any one of third-party device 108A-108N. The credit report may be indicative of one or more user accounts associated with the user. Additionally, the credit report may be indicative of a type of user account for each included user account as well as a corresponding entity the user account is associated with.

As shown by operation 514, the apparatus 200 includes means, such as processor 202, memory 204, communications hardware 206, deployment action circuitry 212, or the like, for identifying one or more user accounts associated with the user. In some embodiments, the deployment action circuitry 212 may identify one or more user accounts associated with the user using a user profile. As described above, a user profile may include one or more user accounts for the user that are associated with the entity that operates apparatus 200 and/or deployment analysis system 102. Thus, the deployment action circuitry 212 may determine a user account for the user and identify one or more user accounts that are internal user accounts. In some embodiments, the user may additionally link one or more external user accounts with his/her user profile such that these external user accounts are also included in the user profile. Each user account may be associated with a user account type. For example, user account types may include a mortgage user account, car loan user account, credit card user account, membership user account, subscription user account, lease user account, and/or the like.

Additionally, in an instance in which the communications hardware 206 receives a credit report for the user, the deployment action circuitry 212 may process the received credit report and identify one or more user accounts associated with the user based on the credit report. The deployment action circuitry 212 may use optical character recognition, natural language processing techniques, and/or other suitable techniques to process the credit report and identify user accounts associated with the user.

As shown by operation 516, the apparatus 200 includes means, such as processor 202, memory 204, communications hardware 206, deployment action circuitry 212, or the like, for determining an eligibility category for each identified user account. Once the deployment action circuitry 212 has identified the one or more user accounts associated with the user, the deployment action circuitry 212 may determine an eligibility category for each identified user account. An eligibility category may be a categorical classification indicative of whether the associated user account is eligible for relief benefits. For example, eligibility categories may include a federal eligible user account, a non-federal eligible user account, or a non-eligible user account. By way of particular example, a home loan or auto loan may be determined to have a federal eligible account eligibility category because these user accounts are associated with user account types protected under SCRA. As another example, a gym membership or magazine subscription service may be determined to be non-federal eligible user accounts because these user accounts may not be protected under SCRA, but action may be taken on behalf of the user to seek relief (e.g., cancel, suspend, unsubscribe from services during deployment).

In some embodiments, the deployment action circuitry 212 may use an account categorization model to determine an eligibility category for each identified user account. The account categorization model may be a rules-based model, such as a decision tree, or a machine-learning model (e.g., a classification neural network) that is configured to process each user account, user account type, and/or entity the user account is associated with (e.g., the entity that manages or offers the user account) to determine an eligibility category for an identified user account. Each user account may be associated with a particular user account type, such as a mortgage user account, car loan user account, credit card user account, membership user account, subscription user account, lease user account, and/or the like. Furthermore, each user account may be associated with an entity that manages the particular user account. For example, a particular financial institution may be associated with a mortgage user account, a credit card institution may be associated with a credit card user account, a gym company may be associated with a gym membership, and a streaming platform may be associated with a subscription user account. Different entities may offer policies that differ from standard policies regarding their treatment of deployed service members. For example, certain entities may allow users to cancel their membership or subscription without a cancellation fee, at a discounted cancellation fee, pause their membership or subscription, and/or the like.

The account categorization model may be configured to determine an eligibility category for each user account based on a defined (e.g., in a rules-based model) or inferred (e.g., in a machine-learning model) rule set. The rule set may be used to define eligibility categories for certain user accounts based on the corresponding account type and/or entity associated with the user account. For example, the rule set may define that a federal eligible user account eligibility category always be determined for a user account that is a mortgage user account type. As another example, the rule set may define that a non-federal eligible user account eligibility category always be determined for entity XYZ.

As shown by operation 518, the apparatus 200 includes means, such as processor 202, memory 204, communications hardware 206, deployment action circuitry 212, or the like, for selecting one or more eligible user accounts for the user. The deployment action circuitry 212 may select one or more eligible user accounts based on the corresponding eligibility category determined for a given user account. In some embodiments, the deployment action circuitry 212 may select any user accounts associated with an eligibility category of federal eligible user account or non-federal eligible user account.

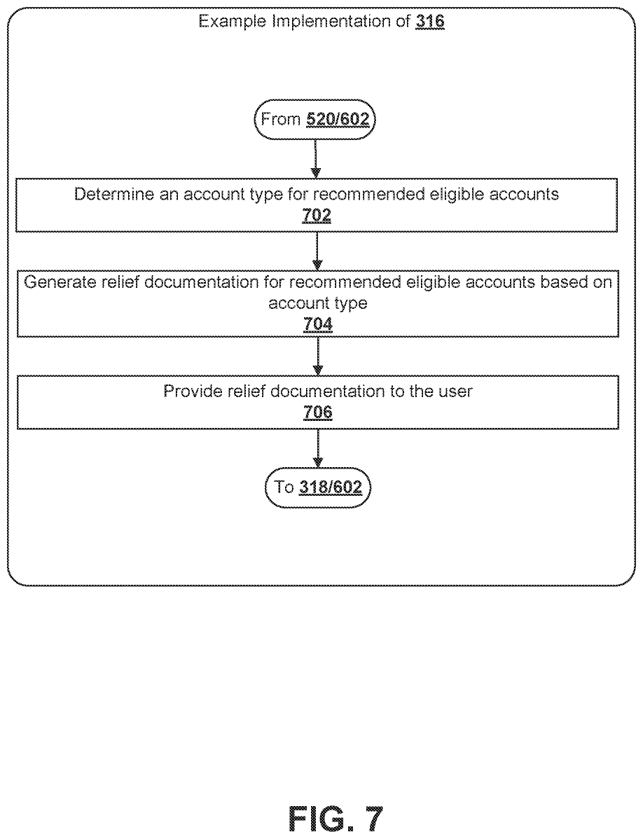

Once the deployment action circuitry 212 selects one or more eligible user accounts for the user, the process may proceed to operation 602 of FIGS. 6 and/or 702 of FIG. 7, where proactive operations may be performed for the user. In particular, FIG. 6 describes example operations for automatically providing deployment notifications to third-party devices associated with selected eligible user accounts. Thus, third-party entities may be made aware of a user's deployment activity such that the proper benefits and/or protections may be applied to a user account. Additionally or alternatively, FIG. 7 describes example operations for automatically generating and providing relief documentation to the user, who may then provide it to a third party. As described above, the deployment action circuitry may determine which proactive operations to perform based on user account type of the user account and user preferences described by a user profile of the user. User preferences may be indicative of user preferences for particular user accounts or user account types with respect to how an entity associated with the particular user account should be informed of the deployment event. Thus, the user preferences allow the user to control what proactive operations are performed for individual user accounts.

Turning first to FIG. 6, as shown by operation 602, the apparatus 200 includes means, such as processor 202, memory 204, communications hardware 206, deployment action circuitry 212, or the like, for determining a requirement set for a selected eligible user account. In some embodiments, a user account may be associated with an external third-party entity. Third-party entities may have their own requirements when it comes to providing relief (e.g., benefits and/or protections) to a user. A requirement set may be indicative of one or more requirements of the selected eligible user account that must be satisfied in order for the user to be obtain relief benefits. In particular, the requirement set may include one or more requirements that a user must satisfy in order to be granted benefits and/or protections offered by a corresponding third-party entity. For example, the third-party entity may require the user provide proof of a deployment status prior to providing the user with relief.

In some embodiments, a requirement set for a third-party entity may be stored and/or maintained in an entity repository, such as in memory 204 or another repository, such that the deployment action circuitry 212 may determine the requirement set for the third party by accessing the entity profile in the entity repository. The entity repository may include an entity profile for one or more third-party entities. The entity profile may include information about the entity (e.g., type of entity, entity size, age, and/or the like) and, further, may include the requirement set for the entity. The requirement set for a particular third-party entity may initially be generated and/or updated by the deployment action circuitry 212 using publicly available information about the third-party entity and/or using previous interactions with the third-party entity as guidance. Additionally or alternatively, the deployment action circuitry 212 may request the third-party entity provide it with requirements and/or updates to requirements such that the requirement set may include accurate and up-to-date requirements for the third-party entity. The deployment action circuitry 212 may periodically or semi-periodically update the requirement set for the third-party entity.

In some embodiments, the deployment action circuitry 212 may determine whether the requirements for a particular third-party entity are met by the user. In some embodiments, the deployment action circuitry 212 may analyze the user profile to determine whether each requirement is met. In some embodiments, as described above, the deployment confirmation response received in operation 312 may include confirmation documentation (e.g., a DD220 form) from the user, and this confirmation documentation is stored in the user profile. In an instance in which the deployment action circuitry 212 determines the user profile fails to satisfy one or more requirements of a particular third-party entity, the deployment action circuitry 212 may provide a request to the user via user device 106A-106N that requests the user to provide information or documentation to satisfy unfulfilled requirements.

Optionally, as shown by operation 604, the apparatus 200 includes means, such as processor 202, memory 204, communications hardware 206, deployment action circuitry 212, or the like, for generating a limited power of attorney for the user to execute. In some embodiments, the deployment action circuitry 212 may generate a limited power of attorney document for the user to execute. The limited power of attorney document may include language authorizing the apparatus 200 and/or authorized users associated with the entity that operates apparatus 200 with the right to represent the user's interest within the scope of seeking deployment relief for a particular amount of time. The limited power of attorney document may be required in order for the deployment action circuitry 212 to generate and provide deployment notifications to third-party entities on behalf of the user.

In some embodiments, the deployment action circuitry 212 may use a limited power of attorney template stored in an associated memory, such as memory 204, to generate the limited power of attorney for the user. In some embodiments, one or more limited power of attorney templates may be stored in memory and may correspond to different legal jurisdictions, such as states. The deployment action circuitry 212 may determine the appropriate limited power of attorney template to select based on the user information in the user profile, such as the user's residential address.

The limited power of attorney template may include template language required by the particular jurisdiction to allow apparatus 200 perform proactive operations on behalf of the user. The limited power of attorney template may additionally include one or more blank fields that the deployment action circuitry 212 may populate using information supplied by the user profile. For example, the one or more blank fields may require the deployment action circuitry 212 to populate these fields with a user's legal name and address.

Optionally, as shown by operation 606, the apparatus 200 includes means, such as processor 202, memory 204, communications hardware 206, or the like, for providing a limited power of attorney request to the user. Once the deployment action circuitry 212 generates the power of attorney, communications hardware 206 may provide a limited power of attorney request that includes the limited power of attorney to the user, such as via user device 106A-106N. The limited power of attorney request may request the user to execute the limited power of attorney by providing a signature and/or dating the limited power of attorney document at designated positions. In some embodiments, the limited power of attorney request may further include a time limit, such as one day, one week, two weeks, etc. The time limit may set a time window within which the user must sign the limited power of attorney or else the limited power of attorney is considered void and needs to be resent.

Optionally, as shown by operation 608, the apparatus 200 includes means, such as processor 202, memory 204, communications hardware 206, deployment action circuitry 212, or the like, for determining whether the user executed the limited power of attorney within a time limit. As described above, the limited power of attorney request may include a time limit during which the user must execute the limited power of attorney. If a user executes the power of attorney, the communications hardware may receive a limited power of attorney response, which includes the executed limited power of attorney. Thus, the deployment action circuitry 212 may determine the user executed the limited power of attorney during the time limit. If a user declines to execute the power of attorney, the communications hardware may receive a limited power of attorney response indicating the user declined to execute the limited power of attorney and may additionally include reasons for the decline. Here, the deployment action circuitry 212 may determine the user failed to execute the limited power of attorney during the time limit. If a user fails to either execute or decline to execute the limited power of attorney during the time window set by the time limit, the deployment action circuitry 212 may automatically determine the user failed to execute the limited power of attorney during the time limit once the time window has passed.

In an instance in which the user fails to execute the limited power of attorney within the time limit, the process may proceed back to operation 606. In some embodiments, in an instance in which the user does not execute or decline to execute the limited power of attorney, the deployment action circuitry 212 may proceed back to operation 606 and provide the limited power of attorney back to the user in a new limited power of attorney request, setting a new time limit.

Alternatively, in an instance in which the user specifically declines to execute the limited power of attorney, the process may proceed to operation 702. If a user specifically declines to execute a limited power of attorney required to provide deployment notifications to the third party on behalf of the user, the deployment action circuitry 212 may instead provide relief documentation to the user as described in more detail in FIG. 7.

In an instance in which the user executes the limited power of attorney within the time limit, the process may proceed back to operation 610. As shown by operation 610, the apparatus 200 includes means, such as processor 202, memory 204, communications hardware 206, deployment action circuitry 212, or the like, for generating deployment notifications for selected eligible user accounts. A deployment notification may be indicative that the user is deployed during the time period of interest. Thus, a third-party entity may be made aware of the user's deployment without the user providing this notification to the third party. A deployment notification may be generated for each selected eligible user account where the deployment action circuitry 212 determined to perform the proactive operation of deployment notification generation and/or provision.

In some embodiments, the deployment action circuitry 212 may generate a deployment notification based on the requirement set for a given third-party entity as determined in operation 602. In particular, the deployment action circuitry 212 may include user deployment information, such as proof of deployment, in the deployment notification. For example, the deployment notification may include deployment confirmation documentation (e.g., a DD220 form) if deployment confirmation documentation is required by the third-party entity. As such, the deployment action circuitry 212 may provide all necessary information regarding a user's deployment status to the third-party entity and, thus, will result in a more efficient and streamlined method of providing deployment status notifications to entities. Furthermore, this streamlined communication reduces the overall number of communications required between the third-party entity, apparatus 200, and/or the user, thereby reducing overall network bandwidth usage.

As shown by operation 612, the apparatus 200 includes means, such as processor 202, memory 204, communications hardware 206, or the like, for providing the deployment notifications to third-party devices associated with corresponding selected eligible user accounts. Once the deployment action circuitry 212 has generated the one or more deployment notifications, the communications hardware 206 may provide each deployment notification to a corresponding third-party device, such as any one of third-party devices 108A-108N. In some embodiments, the communications hardware 206 may determine which third-party devices 108A-108N to provide a corresponding deployment notification to using the entity repository. As described above, the entity repository may include entity profiles for one or more third-party entities, and the entity profile may include information about the entity (e.g., type of entity, entity size, age, and/or the like) as well as third-party devices associated with a respective third-party entity. The communications hardware 206 may use the corresponding entity profile in the entity repository to identify the appropriate third-party devices 108A-108N to provide the deployment notification to.

Turning now to FIG. 7, as shown by operation 702, the apparatus 200 includes means, such as processor 202, memory 204, communications hardware 206, deployment action circuitry 212, or the like, for determining a user account type for selected eligible user accounts. As described above, each user account included in a user profile may be associated with a particular user account type. Thus, the deployment action circuitry 212 may determine the user account type for each user account using the user profile.

As shown by operation 704, the apparatus 200 includes means, such as processor 202, memory 204, communications hardware 206, deployment action circuitry 212, or the like, for generating relief documentation for selected eligible user accounts based on a user account type. The deployment action circuitry 212 may generate relief documentation for each user account based on the user account type. In some embodiments, the deployment action circuitry 212 may use a relief documentation template stored in an associated memory, such as memory 204, to generate relief documentation for each selected eligible user account. Each relief documentation template may be associated with one or more user account types, which may be indicative of which user account types the relief documentation template may be used for. The deployment action circuitry 212 may determine the appropriate relief documentation template to use for a given user account based on the user account type of the given user account and the user account type associated with candidate relief documentation templates. In particular, the deployment action circuitry 212 may determine a relief documentation template that is associated with a user account type that matches the user account type of a user account.

The relief documentation template may include template language generated for the particular user account to provide sufficient notice of a user deployment for the user for the given account type. The relief documentation template may additionally include one or more blank fields that the deployment action circuitry 212 may populate using information supplied by the user profile. For example, the one or more blank fields may require the deployment action circuitry 212 populate these fields with a user's legal name, address, deployment dates, and/or the like.

As shown by operation 706, the apparatus 200 includes means, such as processor 202, memory 204, communications hardware 206, or the like, for providing relief documentation to the user. Once the deployment action circuitry 212 has generated the relief documentation for the one or more selected eligible user accounts, communications hardware 206 may provide all the relief documentation to the user. In particular, the communications hardware 206 may provide the relief documentation to any one or more of user devices 106A-106N. In some embodiments, the communications hardware 206 may determine user devices 106A-106N using a user profile associated with the user. The user profile may pertain to the particular user and include associated user devices (e.g., user devices 106A-106N) and device information, such as phone numbers, identification numbers, serial numbers, international mobile equipment identity numbers, etc.

Turning now to FIG. 3B, as shown by operation 318, the apparatus 200 includes means, such as processor 202, memory 204, communications hardware 206, deployment action circuitry 212, or the like, for determining an end-of-deployment event. An end-of-deployment event may include a date, time, or date range which marks an anticipated or estimated end of deployment for the user. In some embodiments, the deployment action circuitry 212 may determine an end-of-deployment event based on confirmation documentation, if received from the user. For example, confirmation documentation, such as a DD220 form may include a deployment start date and deployment end date such that the deployment action circuitry 212 may determine the end-of-deployment event by processing the confirmation documentation to determine the deployment end date. As described above, the deployment action circuitry 212 may use optical character recognition, natural language processing techniques, and/or other suitable techniques to process the confirmation documentation to identify the deployment end date.

In some embodiments, the deployment action circuitry 212 may use a deployment duration model to determine an end-of-deployment event. The deployment duration model may be a rules-based (e.g., decision tree) or machine-learning model (e.g., neural network) that is configured to process a predicted deployment event and/or user behavior data set for the user and determine an end-of-deployment event. The deployment duration model may be configured with a set of rules that may be used to determine an end-of-deployment event for the user. In some embodiments, the set of rules describe a set of factors that may determine a deployment end date for the user. For example, the deployment duration model may determine whether the branch of the military for the user is known and/or where the user is stationed during deployment. In some embodiments, a user profile may contain this information. Thus, the deployment duration model may use the information available in the user profile to determine a branch of the military the user serves in. The deployment duration model may apply these rules to determine estimate deployment durations and use these estimate deployment durations to determine the deployment end date for the end-of-deployment event. For example, service members in the Navy may have six-month estimate deployment durations, service members in the Marines may have only several-week estimate deployment durations, and service members in the Army may have year-long estimate deployment durations. In some embodiments, the deployment duration model may further use the user behavior data set associated with the user profile to determine an inferred location for the user, similarly as described in operation 406 of FIG. 4. The inferred location for the user may also be used to determine estimate deployment durations.

Additionally or alternatively, the deployment duration model may be a machine-learning model, such as a neural network, that may be trained to infer deployment end dates based on a variety of user parameters. The deployment duration model may be trained using historical user data from user profile associated with users who have previously gone and returned from deployment. This historical user data may be labeled with deployment start and end dates. Thus, the deployment duration model may be configured to determine user parameters, such as military branch, stationed location, user deployment historical data, and/or the like, to determine a deployment end date for the end-of-deployment event.

As shown by operation 320, the apparatus 200 includes means, such as processor 202, memory 204, communications hardware 206, deployment action circuitry 212, or the like, for determining whether a deployment trigger event has been detected. In some embodiments, the deployment action circuitry 212 may monitor for an end-of-deployment trigger event, which may be indicative that a user has returned from a deployment. A deployment trigger event may include a date one day after the date that corresponds to a deployment end date described by the end-of-deployment event. Thus, this is the date the user is predicted to have fulfilled his/her deployment orders and, thus, is returning from deployment.

In some embodiments, a deployment trigger event may correspond to a detection that a user has returned prior to the deployment end date described by the end-of-deployment event. For example, the deployment trigger event may correspond to a detection that a user account, such as a credit card user account, has made an in-person purchase back in the country of origin or has made a particular type of purchase. By way of particular example, the deployment action circuitry 212 may detect a user has made an in-person purchase using a credit card user account at a restaurant nearby his/her residential address. As another example, the deployment trigger event may correspond to a detection of activity associated with a particular user account type. For example, the deployment action circuitry 212 may detect a user medical insurance user account has been used in a domestic healthcare facility. Thus, this may indicate the user has been medically discharged and is no longer deployed.

In an instance in which a deployment trigger event has not been detected, the process may proceed back to operation 320. Thus, the deployment action circuitry 212 may continue to monitor for a deployment trigger event until a deployment trigger event is detected.

In an instance in which a deployment trigger event has been detected, the process may proceed to operation 322. As shown by operation 322, the apparatus 200 includes means, such as processor 202, memory 204, communications hardware 206, deployment action circuitry 212, or the like, for identifying one or more affected user accounts. Once the deployment action circuitry 212 has detected an end-of-deployment trigger event, the deployment action circuitry 212 may identify one or more affected users that were affected by the deployment. In some embodiments, the deployment action circuitry 212 may access a user profile and determine which user accounts were selected, as described in operation 518. The deployment action circuitry 212 may then determine the particular proactive operations performed for each identified user account (e.g., deployment notifications automatically provided or relief documentation provided), and user accounts for which an action was performed may be identified as affected user accounts.

The deployment action circuitry 212 may further determine a status for each affected user account. In particular, the deployment action circuitry 212 may determine a status for an affected user based on the proactive action performed for the user account (e.g., account suspension, unsubscribed, cancellation, and/or the like requested for the user account). Additionally, the deployment action circuitry 212 may analyze internal user accounts to determine whether a particular user account successfully implemented the requested status. For example, if a user had requested to cancel a subscription user account associated with third-party streaming platform, the deployment action circuitry 212 may determine whether the debit user account reflects that payments were no longer made to the third-party streaming platform.

As shown by operation 324, the apparatus 200 includes means, such as processor 202, memory 204, communications hardware 206, deployment action circuitry 212, or the like, for generating an affected account resume request. The deployment action circuitry 212 may generate an affected account resume request that may inform the user of the accounts that have been affected by the deployment as well as a status of those user accounts and may request the user provide input regarding whether to restart the service with the third-party entity. Additionally, the affected account resume request may request the user to confirm the end of his/her deployment, deny the end of his/her deployment and provide a deployment end date, and/or inform the deployment action circuitry 212 of a re-enlistment of deployment extension and provide a new deployment end date. In some embodiments, the affected account resume request may prompt the user to supply confirmation documentation if the user selects a re-enlist interaction element in the affected account resume request, similarly as in the deployment confirmation prompt.

In some embodiments, the deployment action circuitry 212 may further determine whether an original plan, offer, configuration, etc., the user had with the user account is still available. For example, the deployment action circuitry 212 may use web crawlers to visit a product or service offering website for the third-party service and identify what options the third-party service currently offers. In an instance in which the third-party service no longer offers the original plan, offer, configuration, etc., or has changed the terms (e.g., price changes, new restrictions, and/or the like), the deployment action circuitry 212 may provide an indication of this information in the affected account resume request. Thus, the user may be made aware of these changes and can make an informed decision regarding whether to restart the service and/or which plan, offer, or configuration to select.

As shown by operation 326, the apparatus 200 includes means, such as processor 202, memory 204, communications hardware 206, or the like, for providing the affected account resume request to the user. Once the deployment action circuitry 212 has generated the affected account resume request, communications hardware 206 may provide the affected account resume request to the user. In particular, the communications hardware 206 may provide the affected account resume request to any one or more of user devices 106A-106N. In some embodiments, the communications hardware 206 may determine user devices 106A-106N using a user profile associated with the user. The user profile may pertain to the particular user and include associated user devices (e.g., user devices 106A-106N) and device information, such as phone numbers, identification numbers, serial numbers, international mobile equipment identity numbers, etc.

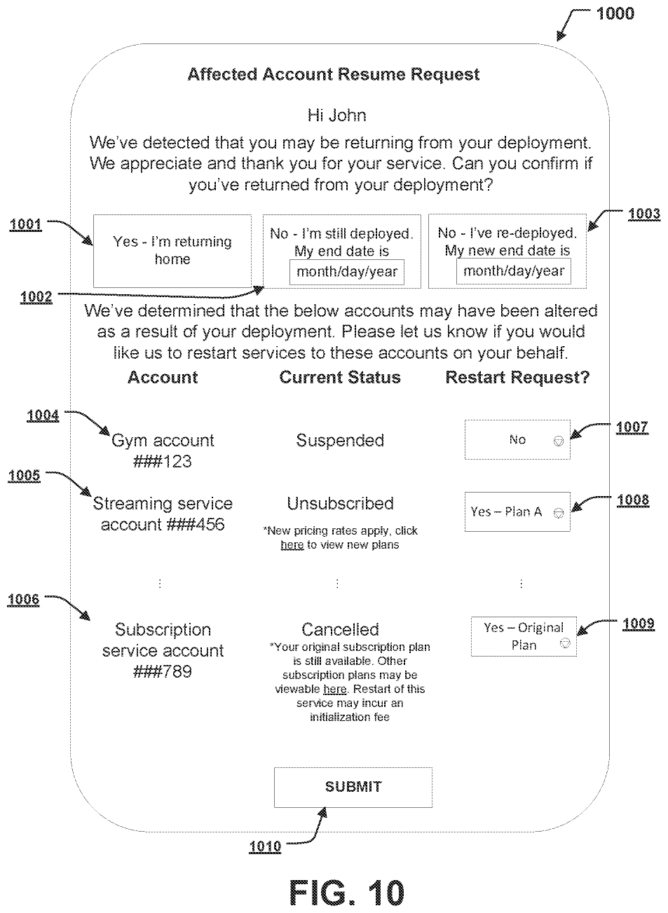

Turning to FIG. 10, a GUI is provided that illustrates an example affected account resume request. As noted previously, a user may interact with the deployment analysis system 102 by directly engaging with communications hardware 206 of an apparatus 200 comprising a system device of the deployment analysis system 102. In such an embodiment, the GUI shown in FIG. 10 may be displayed to a user by the apparatus 200. Alternatively, a user may interact with the deployment analysis system 102 using a separate user device (e.g., any of user devices 106A-106N, as shown in FIG. 1), which may communicate with the deployment analysis system 102 via communications network 104. In such an embodiment, the GUI shown in FIG. 10 may be displayed to the user by the user device.

As shown in FIG. 10, the affected account resume request 1000 may include an indication that an end-of-deployment trigger event has been detected and may request the user to confirm whether his/her deployment is finished, inform deployment action circuitry that he/she is still deployed and provide a correct deployment end date, or inform deployment action circuitry that he/she has extended his/her deployment and provide a correct deployment end date. The affected account resume request 1000 may include user interaction elements 1001, 1002, and 1003. The user may interact with (e.g., click, select, touch, audibly request) element 1001 to confirm he/she is no longer deployed, element 1002 to deny the deployment end date and provide a corrected deployment end date, or element 1003 to provide an indication he/she has re-deployed and provide a new end date. In some embodiments, should a user re-enlist, the affected account resume request 1000 may further include a request for confirmation documentation, such as in the deployment confirmation prompt. The affected account resume request 1000 may further include an indication of the one or more affected user accounts 1004, 1005, and 1006, which may each indicate a current status of the user account as well as information pertaining to changes to the plans, offers, or configurations of the user account. The user interaction element 1007 may be interacted with by the user to select an option regarding user account 1004, user interaction element 1008 may be interacted with by the user to select an option regarding user account 1005, and user interaction element 1009 may be interacted with by the user to select an option regarding user account 1006. The user may select a desired option for each affected user account, including whether to restart the service associated with a user account with the original plan, restart the service associated with a user account with a modified plan, or not restart the service associated with a user account. The affected account resume request 1000 may further include user interaction element 1010 that allows the user to submit his/her responses as an affected account resume response to communications hardware 206.

Returning now to FIG. 3B, as shown by operation 328, the apparatus 200 includes means, such as processor 202, memory 204, communications hardware 206, deployment action circuitry 212, or the like, for determining whether the user confirms to resume one or more of the one or more affected user accounts. In particular, the communications hardware 206 may receive an affected account resume response from a user via any one of user devices 106A-106N. The deployment action circuitry 212 may process the affected account resume response to determine which affected user accounts the user confirms to resume. Additionally, the deployment action circuitry 212 may determine which plan, offer, or configuration the user chose for a particular affected user account that the user requested to be resumed.

In an instance in which the user fails to confirm to resume one or more of the one or more affected user accounts or denies resuming all affected user accounts, the process may proceed to operation 334. The user may not wish to resume any affected user accounts as indicated by the affected account resume response, and thus, the deployment action circuitry 212 may skip operation 330-332.

In an instance in which the user confirms to resume one or more of the one or more affected user accounts, the process proceeds to operation 330. As shown by operation 330, the apparatus 200 includes means, such as processor 202, memory 204, communications hardware 206, deployment action circuitry 212, or the like, for generating a service restart request for the one or more affected user accounts the user confirmed to resume. The deployment action circuitry 212 may generate a service restart request for each affected user account the user indicated he/she wants to resume. The service restart request may include pertinent user information (e.g., user name, user account identifier, user email, user phone number, and/or the like), the type of service requested (e.g., resume paused service, re-enroll cancelled service, resubscribe to service, and/or the like), and a plan, offer, or configuration for the service. As such, the third-party entity may be made aware to resume service for a particular user account.

As shown by operation 332, the apparatus 200 includes means, such as processor 202, memory 204, communications hardware 206, or the like, for providing each service restart request to a third-party computing device associated with a corresponding affected user account. Once the deployment action circuitry 212 has generated the one or more service restart requests, the communications hardware 206 may provide each service restart request to a corresponding third-party device, such as any one of third-party devices 108A-108N. In some embodiments, the communications hardware 206 may determine which third-party devices 108A-108N to provide a corresponding service restart request to using the entity repository, similarly as described above in operation 510 of FIG. 5 and operation 612 of FIG. 6. As described above, the entity repository may include entity profiles for one or more third-party entities and the entity profile may include information about the entity (e.g., type of entity, entity size, age, and/or the like) as well as third-party devices associated with a respective third-party entity. The communications hardware 206 may use the corresponding entity profile in the entity repository to identify the appropriate third-party devices 108A-108N to provide the service restart request to. Upon receipt of a service restart request, the third-party entity may resume service to the corresponding user account using the parameters defined in the service restart request (e.g., the plan, offer, and/or configuration for the service).

As shown by operation 334, the apparatus 200 includes means, such as processor 202, memory 204, communications hardware 206, deployment action circuitry 212, or the like, for generating one or more financial product recommendations. In some embodiments, the deployment action circuitry 212 may further analyze a user profile and generate one or more financial product recommendations for the user to optimize his/her financial assets and/or achieve user goals defined by the user. A financial product recommendation may include an offer for the user for a financial product subject to particular conditions. For example, a financial product recommendation may be a car loan offer, mortgage offer, refinancing offer, or other offer with a particular loan amount, rate, loan term, etc. In some embodiments, the deployment action circuitry 212 may use a user profile analysis model to generate the one or more financial product recommendations.

The user profile analysis model may be a rules-based model or machine-learning model, such as a neural network, that is configured to analyze a user profile and identify one or more areas of need for the user. In some embodiments, the user profile analysis model may further be configured to contemplate needs of a returning service member, whose needs may be different from an average user. For example, a service member may have sold assets and/or cancelled arrangements due to his/her deployment. Thus, the user profile analysis model may analyze historical user behavior and/or assets to identify sold assets, such as cars, houses, etc., or cancelled assets, such as house leases, car leases, etc., and may provide the user with one or more financial product recommendations to regain these assets or arrangements within fiscally responsible boundaries. By way of particular example, if the user profile analysis model determines the user sold his/her car prior to deployment, the user profile analysis model may generate a financial product recommendation that offers a new car loan such that the user may purchase a new vehicle. The amount offered by the car loan may be determined by the user profile analysis model based on the user profile information and, in some embodiments, historical car payments by the user. As such, the user profile analysis model may provide financial product recommendations that address an inferred need of the returning service member in a budget-friendly manner.

As shown by operation 336, the apparatus 200 includes means, such as processor 202, memory 204, communications hardware 206, deployment action circuitry 212, or the like, for providing the one or more financial product recommendations. Once the deployment action circuitry 212 has generated the one or more financial product recommendations, communications hardware 206 may provide the one or more financial product recommendations to the user. In particular, the communications hardware 206 may provide the one or more financial product recommendations to any one or more of user devices 106A-106N. In some embodiments, the communications hardware 206 may determine user devices 106A-106N using a user profile associated with the user. The user profile may pertain to the particular user and include associated user devices (e.g., user devices 106A-106N) and device information, such as phone numbers, identification numbers, serial numbers, international mobile equipment identity numbers, etc.

FIGS. 4-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special-purpose hardware-based computing devices that perform the specified functions, or combinations of special-purpose hardware and software instructions.

### Example System Interaction

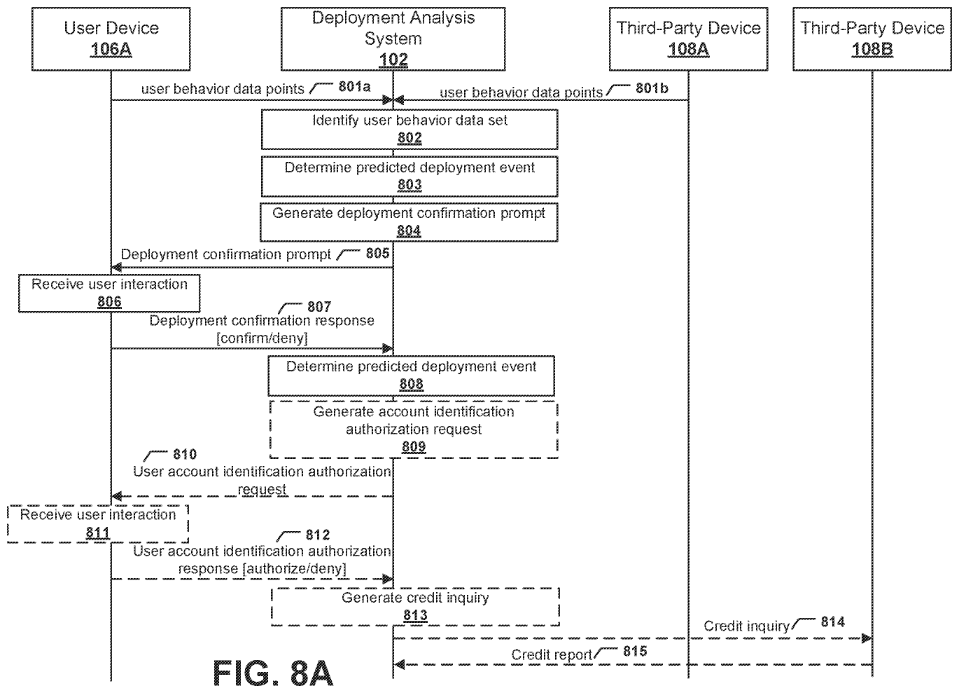

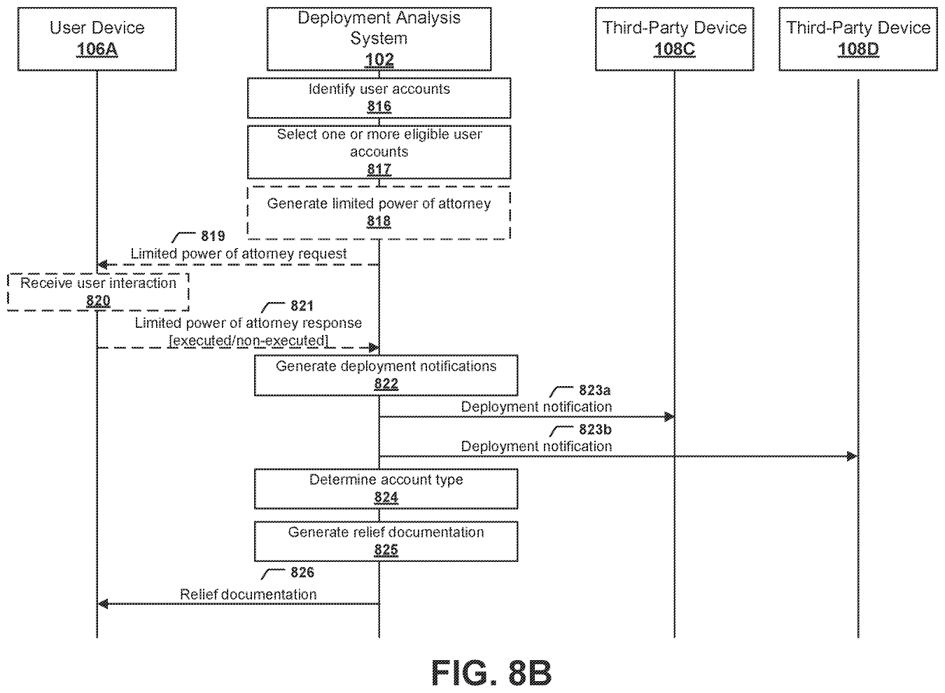

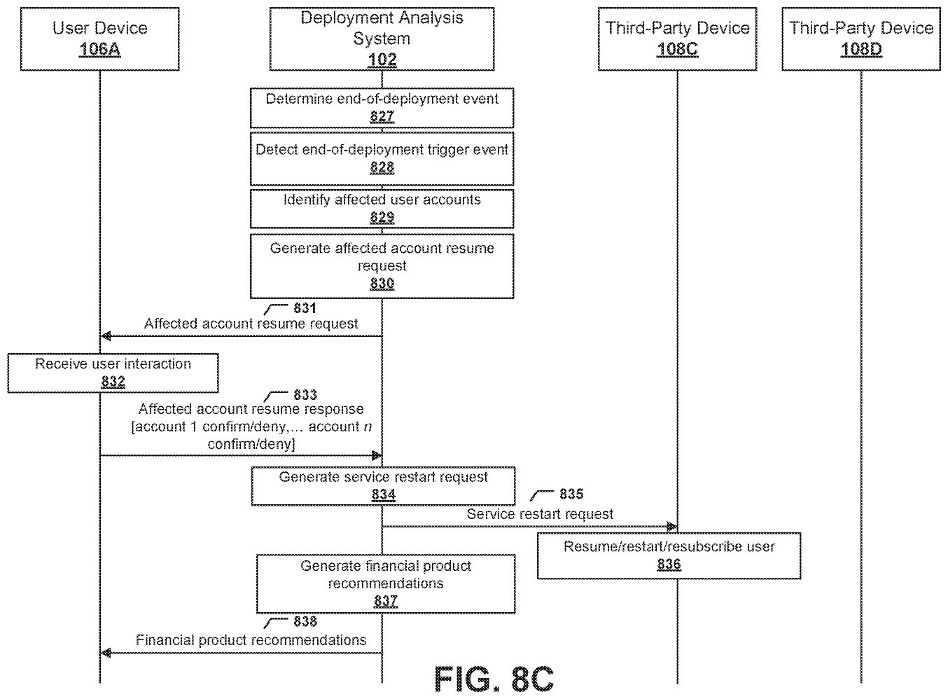

FIGS. 8A-8C show swim lane diagrams illustrating example operations (e.g., as described above in connection with FIGS. 3-7) performed by components of the environment depicted in FIG. 1 to produce various benefits of the implementations described herein. The operations shown in the swim lane diagram performed by user device 106A are shown along the line extending from the box labeled “User Device 106A,” operations performed by a deployment analysis system 102 are shown along the line extending from the box labeled “Deployment Analysis System 102,” operations performed by third-party device 108A are shown along the line extending from the box labeled “Third-Party Device 108A,” operations performed by third-party device 108B are shown along the line extending from the box labeled “Third-Party Device 108B,” operations performed by third-party device 108C are shown along the line extending from the box labeled “Third-Party Device 108C,” and operations performed by third-party device 108D are shown along the line extending from the box labeled “Third-Party Device 108D.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 8A-8C.

At operation 801a, the deployment analysis system 102 may receive user behavior data points from user device 106A. Additionally or alternatively, at operation 801b, the deployment analysis system 102 may receive user behavior data points from third-party device 108A. The deployment analysis system 102 may store these user behavior data points in a user profile associated with the corresponding user. At operation 802, the deployment analysis system 102 may identify a user behavior data set. At operation 803, the deployment analysis system 102 may determine a predicted deployment event for the user. At operation 804, the deployment analysis system 102 may generate a deployment confirmation prompt. At operation 805, the deployment analysis system 102 provides the deployment confirmation prompt to the user device 106A. At operation 806, the user device 106A receives user interaction input for the deployment confirmation prompt. At operation 807, the user device 106A provides a deployment confirmation response to the deployment analysis system 102. At operation 808, the deployment analysis system 102 determines a predicted deployment event.

Optionally, at operation 809, the deployment analysis system 102 generates an account identification authorization request. Optionally, at operation 810, the deployment analysis system 102 provides the user account identification authorization request to the user device 106A. Optionally, at operation 811, the user device 106A receives user interaction input for the account identification authorization request. Optionally, at operation 812, the user device 106A provides a user account identification authorization response to the deployment analysis system 102. Optionally, at operation 813, the deployment analysis system 102 generates a credit inquiry. Optionally, at operation 814, the deployment analysis system 102 provides a credit inquiry to third-party device 108B. Optionally, at operation 815, the third-party device 108B provides a credit report to the deployment analysis system 102.

Turning now to FIG. 8B, at operation 816, the deployment analysis system 102 may identify one or more user accounts. At operation 817, the deployment analysis system 102 may select one or more eligible user accounts. The deployment analysis system 102 may begin to perform one or more proactive operations.

In particular, the deployment analysis system 102 may generate and provide deployment notifications to third-party devices by performing operations 818-823b. Optionally, at operation 818, the deployment analysis system 102 may generate a limited power of attorney. Optionally, at operation 819, the deployment analysis system 102 may provide a limited power of attorney request that includes the limited power of attorney to the user device 106A. Optionally, at operation 820, the user device 106A receives user interaction input for the limited power of attorney request. Optionally, at operation 821, the user device 106A provides a limited power of attorney response to the deployment analysis system 102. At operation 822, the deployment analysis system 102 may generate deployment notifications for selected eligible user accounts. By way of example, the deployment analysis system 102 may determine selected eligible user accounts associated with a first third-party entity that is associated with third-party device 108C and a second third-party entity that is associated with third-party device 108D. Thus, at operation 823a, the deployment analysis system 102 may provide a deployment notification for the first third-party entity to third-party device 108C, and at operation 824b, the deployment analysis system 102 may provide a deployment notification for the second third-party entity to third-party device 108D.

Additionally or alternatively, the deployment analysis system 102 may generate and provide relief documentation to the user by performing operations 824-826. At operation 824, the deployment analysis system 102 may determine a user account type for corresponding user accounts. At operation 825, the deployment analysis system 102 may generate relief documentation for the user accounts. At operation 826, the deployment analysis system 102 may provide the relief documentation generated for each user account to user device 106A.

Turning now to FIG. 8C, at operation 827, the deployment analysis system 102 determines an end-of-deployment event. At operation 828, the deployment analysis system 102 detects an end-of-deployment trigger event. At operation 829, the deployment analysis system 102 identifies affected user accounts. At operation 830, the deployment analysis system 102 generates an affected account resume request. At operation 831, the deployment analysis system 102 provides the affected account resume request to user device 106A. At operation 832, the user device 106A receives user interaction input for the affected account resume request. At operation 833, the user device 106A provides an affected account resume response to the deployment analysis system 102. At operation 834, the deployment analysis system 102 may generate service restart requests for third-party entities indicated by the affected account resume response. For example, an affected account resume request may only indicate a request to resume services for a first third-party entity but not a second third-party entity. At operation 835, the deployment analysis system 102 provides the service restart request to third-party device 108C, which is associated with a requested first third-party entity. At operation 836, the third-party device 108C may resume, restart, resubscribe, etc., a user account associated with the corresponding third-party entity. At operation 837, the deployment analysis system 102 may generate financial product recommendations for the user. At operation 838, the deployment analysis system 102 may provide the financial product recommendations to the user device 106A.

In some embodiments, some of the operations described above in connection with FIGS. 3-7 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved automatic deployment detection for users and enable proactive actions to be taken on the user's behalf. Example embodiments thus provide a time- and resource-efficient solution to a problem many service members face during their upcoming or current deployment. This automated solution allows for the automatic detection of a user deployment by leveraging existing user behavior data to determine a deployment likelihood score for the user. A trained deployment identification machine-learning model trained to infer specific user behavior data points, combinations of user behavior data points, changes in user behavior, etc., indicative of deployment may be used to determine the deployment likelihood score for the user. Thus, in contrast to conventional systems that require the user to manually inform entities of his/her deployment, example embodiments allow a user's deployment to be automatically inferred based on user behavior, thereby lessening the manual burden on the user during an already difficult time. Additionally, automatic detection of deployment may allow for a user's deployment to be determined in a time-efficient manner, which may be advantageous for performing proactive actions for user accounts, as discussed in greater detail below.

Example embodiments provide an automated solution to a conventionally manually intensive process that may be performed in real time or near real time, such as by performing described operations in simultaneously. Thus, this real-time processing may enable the system to perform proactive actions in real time or near real time and, thus, help avoid any benefit or protection delays for user accounts that are time sensitive. While a retroactive fix may be applied to the user account, this results in a waste of computational resources and may require additional computations to correct any improperly applied changes for the user account. Thus, it may be particularly advantageous to perform proactive operations simultaneously to improve the speed at which documentation is generated and provided and, thereby, decrease the risk of changes being applied to a user account that conflict with benefits or protections offered during deployment.

Furthermore, example embodiments described herein monitor for an end-of-deployment trigger event that corresponds to an inference that the user has returned from his/her deployment. In an instance an end-of-deployment trigger event is detected, affected user accounts may be identified and an affected account resume request may be generated and provided to the user. The affected account resume request may provide the user with an indication of the user accounts that were affected by his/her deployment, such as the user accounts to which proactive operations were performed, and may inform the user of an associated status of these user accounts. The affected account resume request may request the user to provide an indication of whether he/she would like to resume one or more of the affected user accounts (e.g., resubscribe, renew, restart, etc.). Additionally, embodiments herein may proactively identify whether an affected user account still offers the original plan, offer, or configuration the user had prior to deployment and, if not, may provide the user with an indication of alternate plans, offers, or configurations. Thus, the user may interact with the affected account resume request to restart one or more desired user accounts, and the system may provide service restart requests to appropriate third-party devices on behalf of the user. Thus, the user is not required to manually determine which user accounts need to be restarted and, further, may automatically be notified of any changes to services or products offered by a third party that may affect his/her decision to restart the service.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for automatically identifying a deployment event for a user, the method comprising:
identifying, by activity monitoring circuitry, a user behavior data set associated with the user;
determining, by deployment analysis circuitry and based on the user behavior data set, a predicted deployment event for the user, wherein (a) the predicted deployment event comprises a deployment likelihood score and a time period of interest, and (b) the deployment likelihood score is indicative of a likelihood that the user is deployed during the time period of interest;
in an instance in which the deployment likelihood score is determined to satisfy a deployment likelihood score threshold, providing, by communications hardware, a deployment confirmation prompt to the user, wherein the deployment confirmation prompt requests the user confirm or deny the predicted deployment event;
receiving, by the communications hardware, a deployment confirmation response, wherein the deployment confirmation response is indicative of user confirmation or denial of the predicted deployment event; and
in an instance in which the user confirms the predicted deployment event, performing, by deployment action circuitry and based on a user profile associated with the user, one or more proactive operations for the user.

2. The method of claim 1, wherein a deployment identification machine-learning model is used to determine the predicted deployment event, and
wherein the method further comprises:
identifying, by the deployment analysis circuitry and using the deployment identification machine-learning model, one or more user behavior data points of interest from the user behavior data set;
determining, by the deployment analysis circuitry and using the deployment identification machine-learning model, one or more deployment indication scores based on the one or more identified user behavior data points of interest; and
determining, by the deployment analysis circuitry and using the deployment identification machine-learning model, the deployment likelihood score based on the one or more deployment indication scores.

3. The method of claim 2, further comprising:
determining, by the activity monitoring circuitry and based on the user behavior data set, an inferred user location;
identifying, by the activity monitoring circuitry, one or more inferred associated users associated with the inferred user location; and
identifying, by the activity monitoring circuitry, a user behavior data set associated with each of the one or more inferred associated users, wherein the deployment likelihood score is further based on the user behavior set associated with each of the one or more inferred associated users.

4. The method of claim 2, further comprising:
training, by deployment analysis circuitry, the deployment identification machine-learning model based on the deployment confirmation response.

5. The method of claim 1, wherein one or more of the one or more proactive operations comprise:
identifying, by the deployment action circuitry and based on the user profile associated with the user, one or more user accounts associated with the user;
determining, by the deployment action circuitry, an eligibility category for each user account of the one or more user accounts associated with the user, wherein the eligibility category is a categorical classification indicative of whether the associated user account is eligible for relief benefits; and
selecting, by the deployment action circuitry and based on a corresponding eligibility category, one or more eligible user accounts from the one or more user accounts associated with the user.

6. The method of claim 5, further comprising:
generating, by the deployment action circuitry, a deployment notification for a selected eligible user account from the one or more user accounts associated with the user, wherein the deployment notification is indicative that the user is deployed during the time period of interest; and
providing, by the communications hardware, the deployment notification to a third-party device associated with the selected eligible user account.

7. The method of claim 6, further comprising:
determining, by the deployment action circuitry, a requirement set for the selected eligible user account, wherein (a) the requirement set is indicative of one or more requirements of the selected eligible user account that must be satisfied in order for the user to be obtain relief benefits, and (b) the deployment notification comprises user deployment information that satisfies the one or more requirements of the requirement set.

8. The method of claim 6, further comprising:
providing, by the communications hardware, a limited power of attorney request to the user, wherein (a) the limited power of attorney request requests the user to execute a limited power of attorney authorizing an entity to perform a particular set of actions for a limited duration of time on behalf of the user, and (b) in an instance in which the limited power of attorney is executed by the user, the deployment notification is provided to the selected eligible user account.

9. The method of claim 5, further comprising:
determining, by the deployment action circuitry, a user account type for a selected eligible user account from the one or more user accounts associated with the user;
generating, by the deployment action circuitry and based on the user account type and the user profile, relief documentation for a selected eligible user account; and
providing, by the communications hardware, the generated relief documentation to the user.

10. The method of claim 5, further comprising:
providing, by the communications hardware, a user credit inquiry authorization request to the user, wherein the user credit inquiry authorization request requests the user to authorize an entity to perform a credit inquiry;
in an instance in which user authorization to perform the credit inquiry is received, providing, by the communications hardware, a credit inquiry for the user; and
receiving, by the communications hardware, a credit report for the user in response to the credit inquiry, wherein identifying the one or more user accounts associated with the user is further based on the credit report.

11. The method of claim 1, further comprising:
determining, by the deployment action circuitry, an end-of-deployment event, wherein the end-of-deployment event is associated with an end date of deployment;
detecting, by the deployment action circuitry, an end-of-deployment trigger event;
in response to detecting the end-of-deployment trigger event, identifying, by the deployment action circuitry and based on the user profile associated with the user, one or more affected user accounts, wherein the one or more affected user accounted are user accounts that were cancelled, suspended, or unsubscribed from during the deployment event;
providing, by the communication hardware, an affected account resume request to the user, wherein the affected account resume request comprises an indication of the affected user accounts and requests the user to indicate whether to resume one or more of the one or more affected user accounts; and
in an instance in which the user confirms to resume one or more of the one or more affected user accounts, providing, by the communications hardware, a service restart request to a third-party device for each of the confirmed one or more of the one or more affected user accounts to resume, wherein the service restart request is indicative to resubscribe, renew, restart, or re-establish a corresponding user account.

12. The method of claim 1,
determining, by the deployment action circuitry, an end-of-deployment event, wherein the end-of-deployment event is associated with an end date of deployment;
detecting, by the deployment action circuitry, an end-of-deployment trigger event;
in response to detecting the end-of-deployment trigger event, generating, by the deployment action circuitry and based on the user profile associated with the user, one or more financial product recommendations; and
providing, by the communications hardware, the one or more recommended financial product recommendations.

13. An apparatus for automatically identifying a deployment event for a user, the apparatus comprising:
activity monitoring circuitry configured to:
identify a user behavior data set associated with the user;
deployment analysis circuitry configured to:
determine, based on the user behavior data set, a predicted deployment event for the user, wherein (a) the predicted deployment event comprises a deployment likelihood score and a time period of interest, and (b) the deployment likelihood score is indicative of a likelihood that the user is deployed during the time period of interest;
communications hardware configured to:
in an instance in which the deployment likelihood score is determined to satisfy a deployment likelihood score threshold, provide a deployment confirmation prompt to the user, wherein the deployment confirmation prompt requests the user confirm or deny the predicted deployment event; and
receive a deployment confirmation response, wherein the deployment confirmation response is indicative of user confirmation or denial of the predicted deployment event; and
deployment action circuitry configured to:
in an instance in which the user confirms the predicted deployment event, perform, based on a user profile associated with the user, one or more proactive operations for the user.

14. The apparatus of claim 13, wherein a deployment identification machine-learning model is used to determine the predicted deployment event; and
wherein the deployment analysis circuitry is further configured to:
identify, using the deployment identification machine-learning model, one or more user behavior data points of interest from the user behavior data set;
determine, using the deployment identification machine-learning model, one or more deployment indication scores based on the one or more identified user behavior data points of interest; and
determine, using the deployment identification machine-learning model, the deployment likelihood score based on the one or more deployment indication scores.

15. The apparatus of claim 14, wherein the activity monitoring circuitry is further configured to:
determine, based on the user behavior data set, an inferred user location;
identify one or more inferred associated users associated with the inferred user location; and
identify a user behavior data set associated with each of the one or more inferred associated users, wherein the deployment likelihood score is further based on the user behavior set associated with each of the one or more inferred associated users.

16. The apparatus of claim 13, wherein the deployment analysis circuitry is further configured to:
identify, based on the user profile associated with the user, one or more user accounts associated with the user;
determine an eligibility category for each identified user account, wherein the eligibility category is a categorical classification indicative of whether the associated user account is eligible for relief benefits; and
select, based on a corresponding eligibility category, one or more eligible user accounts from the one or more user accounts for the user.

17. The apparatus of claim 16, wherein the deployment action circuitry is further configured to generate a deployment notification for a selected eligible user account, wherein the deployment notification is indicative that the user is deployed during the time period of interest; and
the communications hardware is further configured to provide the deployment notification to a third-party device associated with the selected eligible user account.

18. The apparatus of claim 17, wherein the deployment action circuitry is further configured to:
determine a requirement set for the selected eligible user account, wherein (a) the requirement set is indicative of one or more requirements of the selected eligible user account that must be satisfied in order for the user to be obtain relief benefits, and (b) the deployment notification comprises user deployment information that satisfies the one or more requirements of the requirement set.

19. The apparatus of claim 17, wherein the communications hardware is further configured to:
provide a limited power of attorney request to the user, wherein (a) the limited power of attorney request requests the user to execute a limited power of attorney authorizing an entity to perform a particular set of actions for a limited duration of time on behalf of the user, and (b) in an instance in which the limited power of attorney is executed by the user, the deployment notification is provided to the selected eligible user account.

20. A computer program product for automatically identifying a deployment event for a user, the computer program product comprising at least one non-transitory computer-readable storage medium storing software instructions that, when executed, cause an apparatus to:
identify a user behavior data set associated with the user;
determine, based on the user behavior data set, a predicted deployment event for the user, wherein (a) the predicted deployment event comprises a deployment likelihood score and a time period of interest, and (b) the deployment likelihood score is indicative of a likelihood that the user is deployed during the time period of interest;
in an instance in which the deployment likelihood score is determined to satisfy a deployment likelihood score threshold, provide a deployment confirmation prompt to the user, wherein the deployment confirmation prompt requests the user confirm or deny the predicted deployment event;
receive a deployment confirmation response, wherein the deployment confirmation response is indicative of user confirmation or denial of the predicted deployment event; and
in an instance in which the user confirms the predicted deployment event, perform, based on a user profile associated with the user, one or more proactive operations for the user.
